(19) United States
(12) Patent Application Publication
(10) Pub. No.: US 2026/0172101 A1
(43) Pub. Date: Jun. 18, 2026

(54) METHOD AND APPARATUS FOR CONTROLLING BEAM OF WIRELESS REPEATER

(71) Applicant: ELECTRONICS AND TELECOMMUNICATIONS RESEARCH INSTITUTE, Daejeon (KR)

(72) Inventors: Hoon Dong NOH, Daejeon (KR); Ju Ho PARK, Daejeon (KR); YOUNG IL JEON, Daejeon (KR); Hyung Sik JU, Daejeon (KR)

(73) Assignee: ELECTRONICS AND TELECOMMUNICATIONS RESEARCH INSTITUTE, Daejeon (KR)

(21) Appl. No.: 19/110,746

(22) PCT Filed: Sep. 14, 2023
(86) PCT No.: PCT/KR2023/013788

§ 371 Date: Mar. 11, 2025

(30) Foreign Application Priority Data
Sep. 22, 2022 (KR) 10-2022-0120253
Feb. 17, 2023 (KR) 10-2023-0021237
Aug. 22, 2023 (KR) 10-2023-0110028

(51) Int. Cl. H04B 7/06; H04L 5/00

(52) U.S. Cl. CPC H04B 7/06968; H04L 5/0005

(57) ABSTRACT

Disclosed are a method and apparatus for controlling a beam of a wireless repeater. A method for a repeater comprises the steps of: receiving first control information from a base station; confirming one or more beams used by the repeater on the basis of a beam indication field included in the first control information; and relaying communication between the base station and a terminal using the one or more beams.

### TECHNICAL FIELD

The present disclosure relates to a beam control technique, and more particularly, to a beam control technique of a wireless repeater for communication coverage extension.

### BACKGROUND ART

With the advancement of information and communication technology, various wireless communication technologies are being developed. Representative wireless communication technologies may be long term evolution (LTE), LTE-advanced (LTE-A), new radio (NR), and the like specified as the 3^{rd} generation partnership project (3GPP) standards. The LTE and/or LTE-A may be 4^{th} generation (4G) communication technologies and the NR may be a 5^{th} generation (5G) communication technology.

After commercialization of the 4G communication system (e.g., communication system supporting LTE and/or LTE-A), a 5G communication system (e.g., communication system supporting new radio (NR)) using a higher frequency band (e.g., a frequency band of 6 GHz or above) than a frequency band (e.g., a frequency band of 6 GHz or below) of the 4G communication system is being considered for processing of soaring wireless data. The 5G communication system can support enhanced Mobile BroadBand (eMBB), Ultra Reliable Low Latency Communication (URLLC), and/or Massive Machine Type Communication (mMTC).

A network-controlled repeater (NCR) may be introduced in the 5G communication system and/or a communication system (e.g., 6G communication system, future communication system) after the 5G communication system. A base station can control the NCR. The NCR may perform additional signal processing functions as well as an amplification function of a received signal and/or a retransmission function of the signal. In the communication system supporting the NCR, the base station (or network) can control operations of the NCR based on control signals.

Considering the variability of radio channels, the control signal for NCR may be a physical layer control signal. A transmission capacity of the physical layer control signal may be limited to tens to hundreds of bits for each physical layer control signal. Therefore, it may be difficult to specify dozens or more beams and/or resources for the beams by using the physical layer control signals.

### DISCLOSURE

### Technical Problem

The present disclosure for resolving the above-described problems is directed to providing a beam control method and apparatus in a wireless repeater.

### Technical Solution

A method of a repeater, according to exemplary embodiments of the present disclosure for achieving the above-described objective, may comprise: receiving first control information from a base station; identifying one or more beams used by the repeater based on a beam indication field included in the first control information; and relaying communication between the base station and a terminal by using the one or more beams.

The beam indication field may be set to one of a beam index, a quasi-co located (QCL) index, a transmission configuration information (TCI) index, or an index of spatial relation information.

The method may further comprise: identifying a first time resource to which the one or more beams are applied based on a time resource field included in the first control information, wherein the communication between the base station and the terminal may be relayed using the one or more beams in the first time resource.

The method may further comprise: receiving a signaling message including a time resource list from the base station, wherein the time resource field included in the first control information may indicate the first time resource among one or more time resources belonging to the time resource list.

The method may further comprise: identifying a first frequency resource to which the one or more beams are applied based on a frequency resource field included in the first control information, wherein the communication between the base station and the terminal may be relayed using the one or more beams in the first frequency resource.

The method may further comprise: receiving a signaling message including a frequency resource list from the base station, wherein the frequency resource field included in the first control information may indicate the first frequency resource among one or more frequency resources belonging to the frequency resource list.

The method may further comprise: identifying one or more antennas to which the one or more beams are applied based on an antenna indication field included in the first control information, wherein the communication between the base station and the terminal may be relayed using the one or more antennas, the one or more antennas may include at least one of a first antenna or a second antenna of the repeater, the first antenna may be used for communication between the repeater and the base station, and the second antenna may be used for communication between the repeater and the terminal.

The method may further comprise: identifying whether to perform a beam sweeping operation based on a beam management mode field included in the first control information, wherein when the beam management mode field indicates to perform the beam sweeping operation, the communication between the base station and the terminal may be relayed based on the beam sweeping operation.

The method may further comprise: receiving second control information from the base station; and identifying one or more beams used by the repeater based on a beam indication field included in the second control information, wherein when the one or more beams indicated by the first control information are different from the one or more beams indicated by the second control information, the one or more beams used for relaying the communication between the base station and the terminal may be determined based on priorities.

The latest control information among the first control information and the second control information may have a higher priority, and the one or more beams indicated by the latest control information may be used to relay the communication between the base station and the terminal.

Control information indicating a wide beam or a narrow beam among the first control information and the second control information may have a higher priority, and the one or more beams indicated by the control information having the higher priority may be used to relay the communication between the base station and the terminal.

Control information indicating a large number of time resources or a small number of time resources among the first control information and the second control information may have a higher priority, and the one or more beams indicated by the control information having the higher priority may be used to relay the communication between the base station and the terminal.

Control information indicating a large number of frequency resources or a small number of frequency resources among the first control information and the second control information may have a higher priority, and the one or more beams indicated by the control information having the higher priority may be used to relay the communication between the base station and the terminal.

Control information indicating a beam having a high index or a low index among the first control information and the second control information may have a higher priority, and the one or more beams indicated by the control information having the higher priority may be used to relay the communication between the base station and the terminal.

A method of a base station, according to exemplary embodiments of the present disclosure for achieving the above-described objective, may comprise: generating first control information including a beam indication field indicating one or more beams used by a repeater and a time resource field indicating a first time resource to which the one or more beams are applied; and transmitting the first control information to the repeater, wherein communication between the base station and the terminal may be relayed by the repeater using the one or more beams in the first time resource.

The beam indication field may be set to one of a beam index, a quasi-co located (QCL) index, a transmission configuration information (TCI) index, or an index of spatial relation information.

The first control information may further include a frequency resource field indicating a first frequency resource to which the one or more beams are applied, wherein the communication between the base station and the terminal may be relayed by the repeater using the one or more beams in the first time resource and the first frequency resource.

The first control information may further includes an antenna indication field indicating one or more antennas to which the one or more beams are applied, wherein the communication between the base station and the terminal may be relayed using the one or more antennas of the repeater, the one or more antennas may include at least one of a first antenna or a second antenna of the repeater, the first antenna may be used for communication between the repeater and the base station, and the second antenna may be used for communication between the repeater and the terminal.

The first control information may further include a beam management mode field indicating whether to perform a beam sweeping operation, wherein when the beam management mode field indicates to perform the beam sweeping operation, the communication between the base station and the terminal may be relayed based on the beam sweeping operation of the repeater.

The method may further comprise: transmitting to the repeater second control information including a beam indication field indicating one or more beams used by the repeater, wherein when the one or more beams indicated by the first control information are different from the one or more beams indicated by the second control information, the one or more beams of the repeater used for relaying the communication between the base station and the terminal may be determined based on priorities.

### Advantageous Effects

According to the present disclosure, a base station can generate control information for operations of a repeater and transmit the control information to the repeater. The repeater can identify information element(s) included in the control information received from the base station, and can relay communication between the base station and a terminal based on the information element(s). Additionally, the repeater can receive first control information and second control information from the base station. In this case, the repeater can select control information with a higher priority among the first control information and the second control information, and can relay communication between the base station and the terminal using the selected control information. According to the above-described operation, the base station can control the operations of the repeater, and thus the repeater can perform communication efficiently, leading to improvement of the overall performance of the communication system.

### DESCRIPTION OF DRAWINGS

FIG. 1 is a conceptual diagram illustrating an exemplary embodiment of a radio interface protocol structure in a communication system.

FIG. 2 is a conceptual diagram illustrating an exemplary embodiment of time resources in which radio signals are transmitted in a communication system.

FIG. 3 is a conceptual diagram illustrating a time difference between a reception timing of an i-th downlink frame and a transmission timing of an i-th uplink frame in an exemplary embodiment of a communication system.

FIG. 4 is a conceptual diagram illustrating an exemplary embodiment of a time/frequency resource grid of a communication system.

FIG. 5 is a conceptual diagram illustrating an exemplary embodiment of a synchronization signal and physical broadcast channel (SS/PBCH) block or synchronization signal block (SSB) of a communication system.

FIG. 6 is a sequence chart illustrating an exemplary embodiment of a random access procedure in a communication system.

FIG. 7 is a conceptual diagram illustrating a first exemplary embodiment of SSB-RO association according to RACH configuration in a communication system.

FIG. 8 is a conceptual diagram illustrating a second exemplary embodiment of SSB-RO association according to RACH configuration in a communication system.

FIG. 9 is a conceptual diagram illustrating an exemplary embodiment of a QCL information transfer process through TCI state configuration and indication in a communication system.

FIG. 10 is a conceptual diagram illustrating an exemplary embodiment of a TCI state activation/deactivation MAC CE in a communication system.

FIG. 11 is a conceptual diagram illustrating an exemplary embodiment of a TCI state indication MAC CE in a communication system.

FIG. 12 is a conceptual diagram illustrating slot configurations according to slot formats in a communication system.

FIG. 13 is a sequence chart illustrating an exemplary embodiment of a UE capability reporting procedure in a communication system.

FIG. 14A is a conceptual diagram for describing a first exemplary embodiment of a user plane protocol stack structure in a communication system.

FIG. 14B is a conceptual diagram for describing a first exemplary embodiment of a control plane protocol stack structure in a communication system.

FIG. 15 is a conceptual diagram illustrating an exemplary embodiment of an IAB network in a communication system.

FIG. 16 is a conceptual diagram illustrating a first exemplary embodiment of a commercial RF repeater.

FIG. 17 is a conceptual diagram illustrating a first exemplary embodiment of protocol stacks of a control plane and a user plane in a communication system having an RF repeater.

FIG. 18A is a conceptual diagram illustrating a first exemplary embodiment of a protocol stack of a user plane of an advanced repeater.

FIG. 18B is a conceptual diagram illustrating a first exemplary embodiment of a protocol stack of a control plane of an advanced repeater.

FIG. 19 is a conceptual diagram illustrating a first exemplary embodiment of a slot format configuration method.

FIG. 20 is a conceptual diagram illustrating a first exemplary embodiment of NCR.

FIG. 21 is a conceptual diagram illustrating a first exemplary embodiment of a method for mapping a beam index (e.g., beam identifier (ID) to each beam at a repeater antenna.

FIG. 22 is a conceptual diagram illustrating a first exemplary embodiment of a method for changing mapping of a beam index at a repeater antenna.

FIG. 23 is a conceptual diagram illustrating a first exemplary embodiment of a beam indication of a repeater and a beam allocation result according to the beam indication.

FIG. 24 is a conceptual diagram illustrating a second exemplary embodiment of a beam indication of a repeater and a beam allocation result according to the beam indication.

FIG. 25 is a block diagram illustrating a first exemplary embodiment of a base station.

FIG. 26 is a block diagram illustrating a first exemplary embodiment of a repeater.

FIG. 27 is a block diagram illustrating a first exemplary embodiment of a communication node.

### MODE FOR INVENTION

While the present disclosure is capable of various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

In exemplary embodiments of the present disclosure, “at least one of A and B” may refer to “at least one A or B” or “at least one of one or more combinations of A and B”. In addition, “one or more of A and B” may refer to “one or more of A or B” or “one or more of one or more combinations of A and B”.

In the present disclosure, “(re) transmission” may refer to “transmission”, “retransmission”, or “transmission and retransmission”, “(re) configuration” may refer to “configuration”, “reconfiguration”, or “configuration and reconfiguration”, “(re) connection” may refer to “connection”, “reconnection”, or “connection and reconnection”, and “(re) access” may mean “access”, “re-access”, or “access and re-access”.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

A communication network to which exemplary embodiments according to the present disclosure are applied will be described. The communication network to which the exemplary embodiments according to the present disclosure are applied is not limited to the contents described below, and the exemplary embodiments according to the present disclosure may be applied to various communication networks. Here, the communication network may have the same meaning as a communication system. A communication network may refer to a wireless communication network, and a communication system may refer to a wireless communication system.

In the present disclosure, “configuration of an operation (e.g., transmission operation)” may refer to signaling of “control information (e.g., information element, parameter) for the operation” and/or “information indicating to perform the operation”. “An information element (e.g., parameter) is configured” may mean that the corresponding information element is signaled. In the present disclosure, signaling may be at least one of system information (SI) signaling (e.g., transmission of a system information block (SIB) and/or master information block (MIB)), RRC signaling (e.g., transmission of RRC parameters and/or higher layer parameters), MAC control element (CE) signaling, or PHY signaling (e.g., transmission of downlink control information (DCI), uplink control information (UCI), and/or sidelink control information (SCI)).

Throughout the present disclosure, a network may include, for example, a wireless Internet such as wireless fidelity (WiFi), mobile Internet such as a wireless broadband Internet (WiBro) or a world interoperability for microwave access (WiMax), 2G mobile communication network such as a global system for mobile communication (GSM) or a code division multiple access (CDMA), 3G mobile communication network such as a wideband code division multiple access (WCDMA) or a CDMA2000, 3.5G mobile communication network such as a high speed downlink packet access (HSDPA) or a high speed uplink packet access (HSUPA), 4G mobile communication network such as a long term evolution (LTE) network or an LTE-Advanced network, 5G mobile communication network, beyond 5G (B5G) mobile communication network (e.g., 6G mobile communication network), or the like.

Throughout the present disclosure, a terminal may refer to a mobile station, mobile terminal, subscriber station, portable subscriber station, user equipment, access terminal, or the like, and may include all or a part of functions of the terminal, mobile station, mobile terminal, subscriber station, mobile subscriber station, user equipment, access terminal, or the like.

Here, a desktop computer, laptop computer, tablet PC, wireless phone, mobile phone, smart phone, smart watch, smart glass, e-book reader, portable multimedia player (PMP), portable game console, navigation device, digital camera, digital multimedia broadcasting (DMB) player, digital audio recorder, digital audio player, digital picture recorder, digital picture player, digital video recorder, digital video player, or the like having communication capability may be used as the terminal.

Throughout the present disclosure, the base station may refer to an access point, radio access station, node B (NB), evolved node B (eNB), base transceiver station, mobile multihop relay (MMR)-BS, or the like, and may include all or part of functions of the base station, access point, radio access station, NB, eNB, base transceiver station, MMR-BS, or the like.

Hereinafter, preferred exemplary embodiments of the present disclosure will be described in more detail with reference to the accompanying drawings. In describing the present disclosure, in order to facilitate an overall understanding, the same reference numerals are used for the same elements in the drawings, and duplicate descriptions for the same elements are omitted.

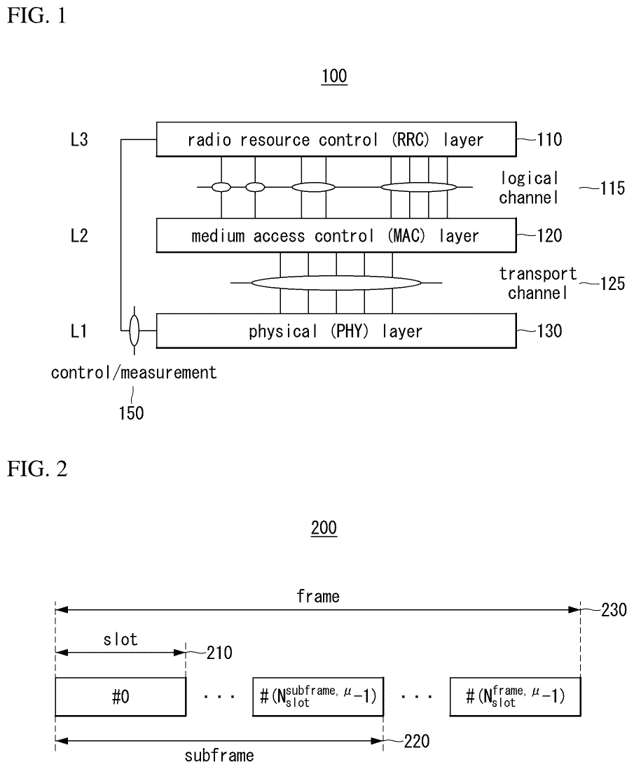

FIG. 1 is a conceptual diagram illustrating an exemplary embodiment of a radio interface protocol structure in a communication system.

Referring to FIG. 1, an exemplary embodiment of a radio interface protocol structure 100 of a communication system may be configured to include a radio resource control (RRC) layer 110, a medium access control (MAC) layer 120, a physical (PHY) layer 130, and the like. An exemplary embodiment of the radio interface protocol structure 100 shown in FIG. 1 may correspond to various exemplary embodiments of interfaces such as an interface between a terminal and a base station, an interface between an IAB-node distributed unit (IAB-DU) and an IAB-node mobile terminal (IAB-MT) of an integrated access backhaul (IAB) network, an interface between an IAB-DU and a lower node, an interface between an IAB-MT and an upper node, an interface between a plurality of terminals, and the like.

In the vicinity of the PHY layer 130, the RRC layer 110, and the MAC layer 120, and the like may be disposed above the PHY layer 130. For example, the MAC layer 120 may be disposed above the PHY layer 130. The RRC layer 110 may be disposed above the MAC layer 120.

The MAC layer 120 may be connected to a higher layer (e.g., RRC layer 110) through logical channels 115. The PHY layer 130 may be connected to the higher MAC layer 120 through transport channels 125. The PHY layer 130 may transmit and receive control information or measurement information 150 to and from the RRC layer 110.

The PHY layer 130 may be referred to as a ‘layer 1’ or ‘L1’. The MAC layer 120 may be referred to as a ‘layer 2’ or ‘L2’. The RRC layer 110 may be referred to as a ‘layer 3’ or ‘L3’. The RRC layer 110 and the MAC layer 120 may be collectively referred to as the ‘higher layer’.

In the present disclosure, ‘L1 signaling’ refers to signaling such as downlink control information (DCI) transmitted on a physical downlink control channel (PDCCH), uplink control information (UCI) transmitted on a physical uplink control channel (PUCCH), and sidelink control information (SCI) transmitted on a physical sidelink control channel (PSCCH), which are channels of the PHY layer 130. Similarly, in the present disclosure, ‘higher layer signaling’ may include L2 signaling transmitted through a MAC control element (CE), L3 signaling transmitted through RRC signaling, and the like.

In a communication system to which the 5G communication technology, etc. is applied, one or more of numerologies of Table 1 may be used in accordance with various purposes, such as inter-carrier interference (ICI) reduction according to frequency band characteristics, latency reduction according to service characteristics, and the like.

TABLE 1

| μ | Δf = 2^{μ} · 15 [kHz] | Cyclic prefix |
|---|---|---|
| 0 | 15 | Normal |
| 1 | 30 | Normal |
| 2 | 60 | Normal, Extended |
| 3 | 120 | Normal |
| 4 | 240 | Normal |

Table 1 is merely an example for the convenience of description, and exemplary embodiments of the numerologies used in the communication system may not be limited thereto. Each numerology u may correspond to information of a subcarrier spacing (SCS) Δf and a cyclic prefix (CP). The terminal may identify a numerology u and a CP value applied to a downlink bandwidth part (BWP) or an uplink BWP based on higher layer parameters such as subcarrierSpacing, cyclicPrefix, and/or the like.

FIG. 2 is a conceptual diagram illustrating an exemplary embodiment of time resources in which radio signals are transmitted in a communication system.

Referring to FIG. 2, time resources in which radio signals are transmitted in a communication system 200 may be represented with a frame 220 comprising one or more

$$( {N}_{slot}^{frame , μ} / {N}_{slot}^{subframe , μ} )$$

subframes, a subframe 220 comprising one or more

$$( {N}_{slot}^{subframe , μ} )$$

slots, and a slot 210 comprising 14

$$( {N}_{symb}^{slot} )$$

OFDM symbols. In this case, according to a configured numerology, as the values of

$${N}_{symb}^{slot} , {N}_{slot}^{subframe , μ} , and {N}_{slot}^{frame , μ} ,$$

values according to Table 2 below may be used in case of a normal CP, and values according to Table 3 below may be used in case of an extended CP. The OFDM symbols included within one slot may be classified into ‘downlink’, ‘flexible’, or ‘uplink’ by higher layer signaling or a combination of higher layer signaling and L1 signaling.

TABLE 2

| μ | ${N}_{s y m b}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |

TABLE 3

| μ | ${N}_{s y m b}^{slot}$ | ${N}_{slot}^{frame , μ}$ | ${N}_{slot}^{subframe , μ}$ |
|---|---|---|---|
| 2 | 12 | 40 | 4 |

In the 5G NR communication system, the frame 230 may have a length of 10 ms, and the subframe 220 may have a length of 1 ms. Each frame 230 may be divided into two half-frames having the same length, and the first half-frame (i.e., half-frame 0) may be composed of subframes #0 to #4, and the second half-frame (i.e., half-frame 1) may be composed of subframes #5 to #9. One carrier may include a set of frames for uplink (i.e., uplink frames) and a set of frames for downlink (i.e., downlink frames).

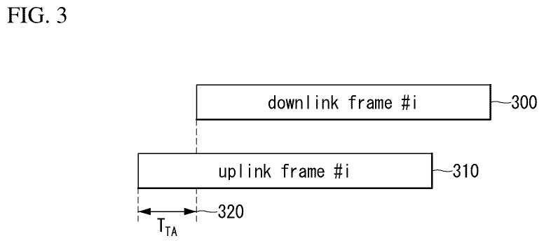

FIG. 3 is a conceptual diagram illustrating a time difference between a reception timing of an i-th downlink frame and a transmission timing of an i-th uplink frame in an exemplary embodiment of a communication system.

Referring to FIG. 3, a time difference between a reception timing of an i-th downlink frame 300 and a transmission timing of an i-th uplink frame 310 may be a TTA 320. Accordingly, the terminal may start transmission of the uplink frame #i 310 at a time earlier by TTA compared to the reception timing of the downlink frame #i 300. TTA may be referred to as a timing advance or timing adjustment TA. The base station may instruct the terminal to change a value of TTA through higher layer signaling or L1 signaling, and may configure the terminal to apply TTA in a manner defined as T_{TA}=(N_{TA}+N_{TA,offset})T_{c}. In the case of 5G NR, T_{c} may be defined as

$${T}_{c} = \frac{1}{( Δ {f}_{m ax} \cdot {N}_{f} )} , Δ {f}_{m ax}$$

may be defined as Δfₘₐₓ=480 kHz, N_{f} may be defined as N_{f}=4096, N_{TA,offset} may be a value set by L3 signaling, and N_{TA} may be a value determined by Equation 1 below by a value T_{A} indicated by L2 signaling.

$${N}_{T A} = \{ \begin{matrix}{T}_{A} \cdot 16 \cdot \frac{64}{{2}^{μ}} & ( for random access response ) \\ {N}_{TA \_ old} + ( ( {T}_{A} - 31 ) \cdot 16 \cdot 64 / {2}^{μ} ) & ( for other cases )\end{matrix} \qquad [ Equation 1 ]$$

Here, the description on N_{TA,offset} and N_{TA} may be an example for a specific situation, and various other options may exist, but in order not to obscure the gist of the description, all possible cases may not be listed in the present disclosure.

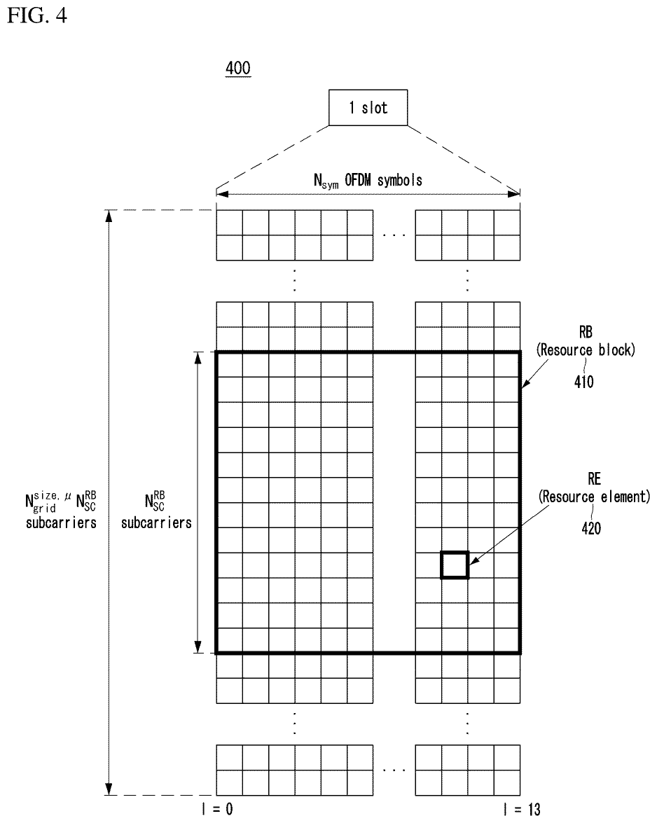

FIG. 4 is a conceptual diagram illustrating an exemplary embodiment of a time/frequency resource grid of a communication system.

Referring to FIG. 4, a time/frequency resource grid 400 of a communication system may have

$${N}_{g r i d}^{size , μ} {N}_{sc}^{R B}$$

subcarriers and

$${N}_{slot}^{subframe , μ}$$

OFDMs. The resource grid may be defined for each numerology and each carrier. In this case,

$${N}_{g r i d}^{start , μ}$$

may mean a position of a common resource block (CRB) indicated by higher layer signaling.

$${N}_{g r i d}^{size , μ}$$

may mean the number of resource blocks (RBs) starting from the CRB, that is, a carrier bandwidth.

$${N}_{g r i d}^{start , μ} and / or {N}_{g r i d}^{size , μ}$$

may have different values for each link direction (e.g., uplink, downlink, or sidelink) or for each numerology μ. Here, the numerology u may be referred to by other terms, such as a SCS configuration, if necessary.

Each element in the resource grid for an antenna port p and a SCS configuration u may be referred to as a resource element (RE) 420, and may be uniquely defined for each position (k, l)_{p,μ}. In this case, k may be a frequency axis index, and l may indicate a symbol position on the time axis. RE(k, l)_{p,μ} may correspond to a physical resource used to transmit a physical channel or a signal complex value

$${a}_{k , l}^{( p , μ )} .$$

One KB 410 may be defined as consecutive

$${N}_{s c}^{R B} = 12$$

subcarriers on the frequency axis.

The 5G NR communication system has introduced the concept of BWPs in order to reduce high implementation complexity and power consumption of terminals due to the widened carrier bandwidth compared to the 3G/4G communication system. One BWP may be composed of contiguous CRBs, a starting RB position

$${N}_{B WP , i}^{start , μ}$$

of the BWP and the number

$${N}_{BWP , i}^{s ize , μ}$$

of RBs constituting the BWP may satisfy Equations 2 and 3.

$${N}_{g r id , x}^{s t art , μ} \leq {N}_{B WP , i}^{s t a r t , μ} < {N}_{grid , x}^{s t art , μ} + {N}_{g rid , x}^{s i z e , μ} \qquad [ Equation 2 ]$$

$${N}_{g r id , x}^{s t art , μ} < {N}_{B WP , i}^{s t a r t , μ} + {N}_{B WP , i}^{s ize , μ} \leq {N}_{g r id , x}^{s t art , μ} + {N}_{grid , x}^{size , μ} \qquad [ Equation 3 ]$$

Up to four downlink BWPs within one component carrier (CC) may be configured for one terminal, and only one downlink BWP may be activated at a time. The terminal may not receive a physical downlink shared channel (PDSCH), a physical downlink control channel (PDCCH), a channel state information reference signal (CSI-RS), or the like outside the activated BWP.

Up to four uplink BWPs within one CC may be configured for one terminal, and only one uplink BWP may be activated at a time. The terminal may not transmit a physical uplink shared channel (PUSCH), a physical uplink control channel (PUCCH), a sounding reference signal (SRS), or the like outside the activated BWP.

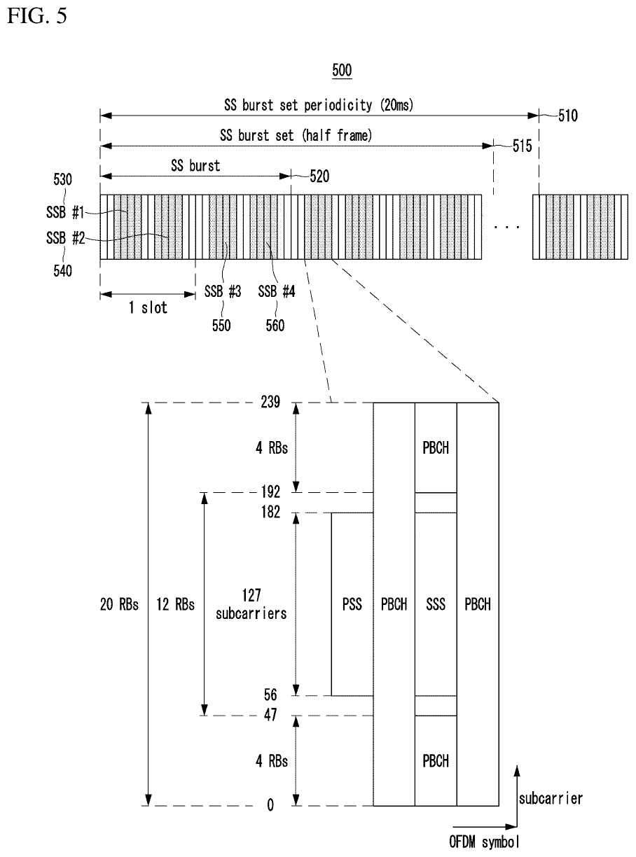

FIG. 5 is a conceptual diagram illustrating an exemplary embodiment of a synchronization signal and physical broadcast channel (SS/PBCH) block or synchronization signal block (SSB) of a communication system.

Referring to FIG. 5, an SS/PBCH block 500 of a communication system may be configured with a primary synchronization signal (PSS) transmitted in 127 subcarriers in the middle of a first OFDM symbol, a secondary synchronization signal (SSS) transmitted in 127 subcarriers in the middle of a third OFDM symbol, and a physical broadcast channel (PBCH) transmitted in second, third, and fourth OFDM symbols. The PBCH occupying the widest bandwidth may be transmitted over 20 RBs, which may be 3.6 MHz based on 15 kHz SCS. The base station transmits one SSB by applying the same beam. When the number of base station antennas increases or it is necessary to operate multiple beams such as applying one or more analog beams for high frequency support, the base station may support a multi-beam operation by transmitting multiple SSBs. Here, the term ‘beam’ may be expressed in various terms such as a transmission precoding or a spatial transmission (TX) filter when applied in practice. However, in order not to obscure the gist of the description, ‘beam’ is used hereinafter as a unified term.

For example, the base station may transmit a plurality of SSBs 530, 540, 550, and 560 to represent a plurality of beams (e.g., beam #1, beam #2, beam #3, beam #4). In this case, it may be possible that one or more SSBs are transmitted within one slot according to a pattern predetermined according to each numerology. The SSBs 530, 540, 550, and 560 to which different beams are applied may be bundled into one set by being included in an SS burst 520. The terminal may assume a half-frame window having a length of 5 ms at the time of monitoring SSBs. An SS burst set 515 configured by higher layer signaling within a half-frame may include one or more SS bursts 520. If RRC configuration values are unknown or unavailable when performing initial access (IA), the terminal may receive or measure the SSBs assuming that a periodicity of the SS burst set 510 is 20 ms. As an example, the terminal may receive SSB(s) with reference to SSB configuration information identical or similar to that shown in Table 4 and Table 5.

TABLE 4

| | |
|---|---|
| MIB ::= | SEQUENCE { |

```
  systemFrameNumber
  subCarrierSpacingCommon
```

| | |
|---|---|
| ssb-SubcarrierOffset | // SSB subcarrier offset (0~15) |

```
  dmrs-TypeA-Position
  pdcch-ConfigSIB1
  cellBarred
  intraFreqReselection
  spare
}
```

| | |
|---|---|
| MeasObjectNR ::= | SEQUENCE { |
| ssbFrequency | // Absolute Radio Frequency Channel Number (ARFCN) of SSB |
| ssbSubcarrierSpacing | // Numerology of SSB |

```
  smtc1
      // first SSB measurement timing configuration (SMTC) configured with reference to
    smtc2 // Second SMTC configured with reference to SSB-MTC
  ...
  ...
}
```

| | |
|---|---|
| SSB-Index | // SSB index within SS-burst |

TABLE 5

| | |
|---|---|
| SSB-MTC ::= | SEQUENCE { |

// timing occasion configuration for SSBs to be measured by terminal

| | |
|---|---|
| periodicityAndOffset | CHOICE { |

```
    sf5 // offset when a SSB reception window has a legnth of 5 subframes
    sf10 // offset when a SSB reception window has a legnth of 10 subframes
    sf20 // offset when a SSB reception window has a legnth of 20 subframes
    sf40 // offset when a SSB reception window has a legnth of 40 subframes
    sf80 // offset when a SSB reception window has a legnth of 80 subframes
    sf160 // offset when a SSB reception window has a legnth of 160 subframes
  },
```

| | |
|---|---|
| duration | // a lengh of a SSB recepion window (number of subframes) |

}

| | |
|---|---|
| SSB-MTC2 ::= | SEQUENCE { |

| | |
|---|---|
| pci-List | // physical cell IDs (PCIs) following the SMTC configuration |
| periodicity | // SMTC periodicity (number of subframes) |

}

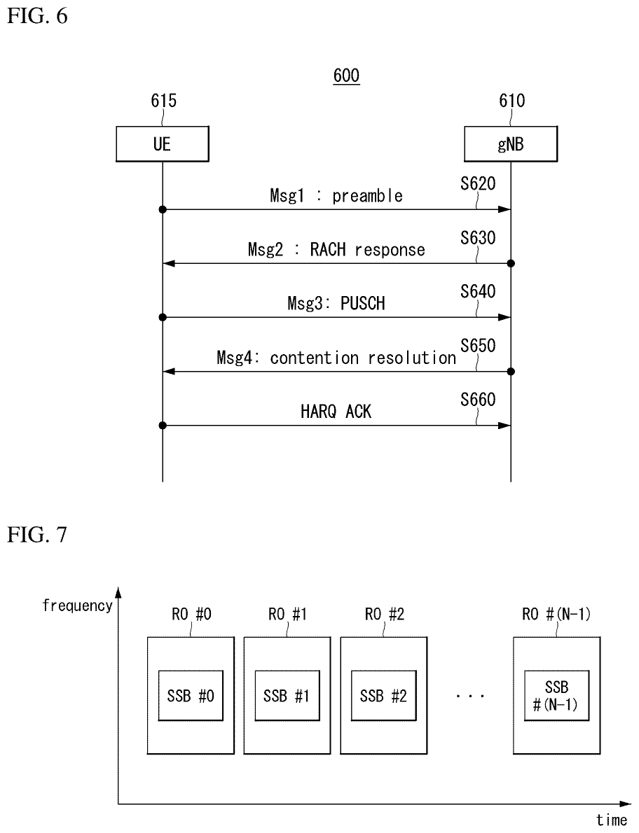

FIG. 6 is a sequence chart illustrating an exemplary embodiment of a random access procedure in a communication system.

Referring to FIG. 6, in a random access procedure of a communication system 600, a terminal 615 may transmit a physical random access channel (PRACH) preamble, and the PRACH preamble may be referred to as ‘Msg1’ (S620). Through a transmission of the PRACH preamble, random access-radio network temporary identifier (RA-RNTI) may be determined. In this case, the RA-RNTI may be calculated by Equation 4.

$$RA - RNTI = 1 + s\_id + 14 \times t\_id + 14 \times 80 \times f\_id + 14 \times 80 \times 8 \times ul\_carrier \_id \qquad [ Equation 4 ]$$

In Equation 4, s_id may be an index of a first OFDM symbol of a corresponding PRACH occasion (e.g., 0≤s_id<14), t_id may be an index of a first slot of the PRACH occasion within a system frame (e.g., 0≤t_id<80), f_id may be an index of the PRACH occasion in the time domain (e.g., 0≤f_id<8), and ul_carrier_id may be a value according to a uplink carrier type used for the preamble transmission (e.g., 0 indicates a regular uplink carrier, 1 indicates a supplementary uplink carrier).

Before the terminal transmits the PRACH preamble, the terminal may have at least part of the following information by receiving system information from the base station on a PBCH or receiving RRC signaling from the base station.
PRACH preamble format
Time/frequency resource information for RACH transmission
Index for a logical root sequence table
Cyclic shift N_{CS}
Set type (unrestricted, restricted set A, restricted set B)

Referring again to FIG. 6, as a second procedure, the base station may provide a random access response (RAR) to the terminal, which may be referred to as ‘Msg2’ (S630). Particularly, the base station may calculate an RA-RNTI based on Equation 4 when the base station receives the PRACH preamble from the terminal in the step S620, and may transmit a DCI by using the RA-RNTI for scrambling. The terminal may monitor a PDCCH scrambled with the RA-RNTI in a period included in a RACH response window configured by the higher layer in a type 1 PDCCH common search space (CSS). The terminal may receive the PDCCH (or the DCI transmitted from the base station through the PDCCH), and may decode the PDCCH (or the DCI). If the terminal successfully decodes the PDCCH (or the DCI), the terminal may decode a PDSCH including the RAR transmitted from the base station in the step S630. If the terminal succeeds in decoding the RAR, the terminal may identify whether an RA preamble identifier (RAPID) in the RAR matches a RAPID pre-allocated to the terminal.

As a third procedure, the terminal may transmit a PUSCH to the base station, which may be referred to as ‘Msg3’ (S640). To this end, the terminal may determine whether to apply a transform precoding to transmission of the PUSCH (i.e., whether to apply discrete Fourier transform (DFT)-s-OFDM-based transmission or OFDM-based transmission) based on a higher layer parameter (e.g., msg3-transformPrecoding). Also, the terminal may determine a SCS to be used for transmission of the PUSCH according to a higher layer parameter (e.g., msg3-scs). In this case, the PUSCH of Msg3 may be transmitted through a serving cell to which the PRACH has been transmitted.

As a fourth procedure, the base station may transmit a contention resolution message to the terminal, which may be referred to as ‘Msg4’ (S650). The terminal may start a timer for receiving the contention resolution message, and may monitor a PDCCH scrambled with a temporary cell-RNTI (TC-RNTI) in the type 1 PDCCH CSS until the timer expires. If the terminal successfully decodes the PDCCH, the terminal may decode a corresponding PDSCH including a MAC CE, and set the TC-RNTI as a cell-RNTI (C-RNTI). After successfully decoding the Msg4, the terminal may report a hybrid automatic repeat request (HARQ) positive-acknowledgement (ACK) thereto to the base station, and may report whether the RACH procedure is successful to the base station (S660).

The RACH occasion (RO) may mean a time and frequency resource specified for reception of a RACH preamble, and the terminal may use the RO for PRACH transmission. As described above, in the 5G NR, multiple SSBs may be associated with different beams for the multi-beam operation, and the terminal may measure the multiple SSBs, and select an optimal SSB (i.e., optimal beam) based on one of various schemes such as a reference signal received power (RSRP), reference signal received quality (RSRQ), signal-to-noise ratio (SNR), signal-to-noise/interference ratio (SNIR), or the like. Thereafter, the terminal may determine a beam (i.e., TX spatial filter) to be used for PRACH transmission based on the beam (i.e., RX spatial filter) used when receiving the optimal SSB. In this case, a relationship between SSB(s) and RO(s) may be established for the purpose of allowing the base station or the network to know which SSB (i.e., beam) the terminal has selected. Through such the relationship, the base station may know the SSB (i.e., beam) selected by the terminal based on the RO in which the terminal has transmitted the PRACH. For example, the relationship between SSB(s) and RO(s) may be determined with reference to the higher layer configurations identical or similar to those shown in Table 6 and Table 7.

TABLE 6

| | |
|---|---|
| RACH-ConfigCommon ::= | SEQUENCE { |

```
  rach-ConfigGeneric // set of RACH parameters
  totalNumberOfRA-Preambles // the total number of RACH preambles (1~63)
  ssb-perRACH-OccasionAndCB-PreamblesPerSSB CHOICE {
    oneEighth // The number of preambles per SSB when one SSB is associated with eight ROs
    oneFourth // The number of preambles per SSB when one SSB is associated with four ROs
    oneHalf // The number of preambles per SSB when one SSB is associated with two ROs
    one // The number of preambles per SSB when one SSB is associated with one RO
    two // The number of preambles per SSB when two SSBs are associated with one RO
    four // The number of preambles per SSB when four SSBs are associated with one RO
      eight // The number of preambles per SSB when eigth SSBs are associated with one
RO
      sixteen // The number of preambles per SSB when sixteen SSBs are associated with
one RO
    }
```

| | |
|---|---|
| groupBconfigured | SEQUENCE { |

```
    ra-Msg3SizeGroupA // The size of a transport block fro contention-based RA of Group A
    messagePowerOffsetGroupB // Threshold for preamble selection
    numberOfRA-PreamblesGroupA // The number of CB preambles per SSB of Group A
}
```

```
TABLE 7
  ra-ContentionResolutionTimer // Initial value of a contention resolution timer
  rsrp-ThresholdSSB // Threshold for selection of an SSB and an associated RACH resource
  rsrp-ThresholdSSB-SUL // Threshold for selection of an SSB and an associated RACH resource
in SUL
```

| | |
|---|---|
| prach-RootSequenceIndex | CHOICE { // RACH root sequence index |

```
    l839
    l139
  },
  msg1-SubcarrierSpacing // SCS for Msg1 transmission
  restrictedSetConfig // one of {unrestricted, restricted set A, restricted set B}
  msg3-transformPrecoder // whether to apply transform precoding in transmisison of Msg3
  ...
}
```

| | |
|---|---|
| RACH-ConfigGeneric ::= | SEQUENCE { |

```
  prach-ConfigurationIndex // indicates a preamble format, etc.
  msg1-FDM // The number of ROs FDMed at a time
  msg1-FrequencyStart // frequency-axis offset of the lowest RO with reference to PRB 0
    zeroCorrelationZoneConfig // N-CS configuration
  preambleReceivedTargetPower // Target power level at a network receiving node
    preambleTransMax
      // The maximum number of RA preambe transmissions performed unitl declaration of
an RA failure
    powerRampingStep // Power ramping step
  ra-Response Window // Msg2 (RAR) window length (number of slots)
  ...,
}
```

FIG. 7 is a conceptual diagram illustrating a first exemplary embodiment of SSB-RO association according to RACH configuration in a communication system.

Referring to FIG. 7, in an SSB-RO mapping relation according to the RACH configurations, in a certain frequency band, N SSBs 710-1 to 710-n having time resources which are separated from each other may be mapped to ROs 720-1 to 720-n having time resources which are separated from each other on a one-to-one basis. For example, if a higher layer parameter msg1-FDM is set to 1 (i.e., msg1-FDM=one) and a higher layer parameter ssb-perRACH-OccasionAndCB-PreamblesPerSSB is set to 1 (e.g., ssb-perRACH-OccasionAndCB-PreamblesPerSSB=one), the N different SSBs 710-1 to 710-n may be mapped to the N different ROs 720-1 to 720-n on a one-to-one basis.

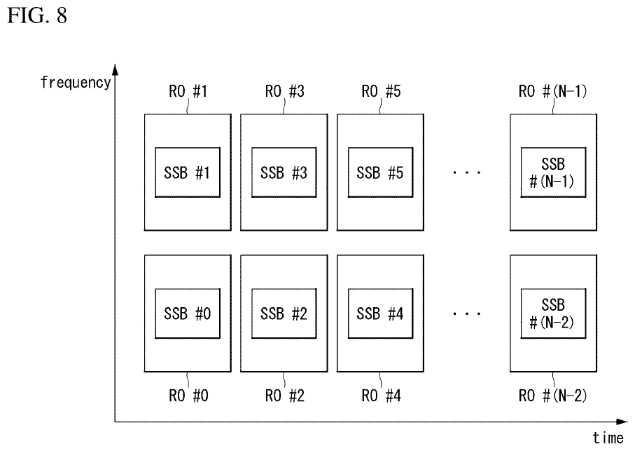

FIG. 8 is a conceptual diagram illustrating a second exemplary embodiment of SSB-RO association according to RACH configuration in a communication system.

Referring to FIG. 8, in an SSB-RO mapping relation according to the RACH configurations, in a first frequency band, SSBs 810-1, 810-3, 810-5, . . . , and 810-(n−1) having time resources which are separated from each other may be mapped to ROs 820-1, 820-3, 820-5, . . . , and 820-(n−1) having time resources which are separated from each other on a one-to-one basis. In addition, in a second frequency band, SSBs 810-2, 810-4, 810-6, . . . , and 810-n having time resources which are separated from each other may be mapped to ROs 820-2, 820-4, 820-6, . . . , and 820-n) having time resources which are separated from each other on a one-to-one basis. For example, if the higher layer parameter msg1-FDM is set to 2 (i.e., msg1-FDM=two), and higher layer parameter ssb-perRACH-OccasionAndCB-PreamblesPerSSB is set to 2 (e.g., ssb-perRACH-OccasionAndCB-PreamblesPerSSB=two), the N different SSBs 810-1 to 810-n may be mapped to the N different ROs 820-1 to 820-n which are frequency division multiplexed (FDMed) in a frequency domain, on a one-to-one basis.

Meanwhile, the 5G NR communication system may support DCI formats shown in Table 8 based on Release-16.

TABLE 8

| DCI | |
|---|---|
| format | Usage |
| 0_0 | Used for scheduling a PUSCH within one cell |
| 0_1 | Used for scheduling one or more PUSCHs within one cell, or indicating |
| | downlink feedback information for a configured grant (CG) PUSCH (i.e., CG- |
| | DFI) |
| 0_2 | Used for scheduling a PUSCH within one cell |
| 1_0 | Used for scheduling a PDSCH within one cell |
| 1_1 | Used for scheduling a PDSCH within one cell or triggering a one-shot HARQ- |
| | ACK codebook feedback |
| 1_2 | Used for scheduling a PDSCH within one cell |
| 2_0 | Used for notifying a slot format, an available RB set, a channel occupancy |
| | time (COT) duration, and search space set group switching to a UE group |
| 2_1 | Used for notifying PRB(s) and OFDM symbol(s) assumed not to be intended |
| | to be used for transmission to a UE group |
| 2_2 | Used for transmission of a transmission power control (TPC) for a PUCCH |
| | and a PUSCH |
| 2_3 | Used for transmission of a TPC command group for SRS transmission by one |
| | or more UEs |
| 2_4 | Used for a UE to notify PRB(s) and OFDM symbol(s) for which UL |
| | transmission from the UE is cancelled to a UE group |
| 2_5 | Used for notifying availability of soft resources |
| 2_6 | Used for notifying power saving information outside a DRX active time to |
| | one or more UEs |
| 3_0 | Used for NR sidelink scheduling within one cell |
| 3_1 | Used for LTE sidelink scheduling within one cell |

A DCI may include downlink control information for one or more cells, and may be associated with one RNTI. The DCI may be encoded through the order of 1) information element multiplexing, 2) cyclic redundancy check (CRC) addition, 3) channel coding, and 4) rate matching, and decoding may also be performed in consideration of the above steps. In the above description, “a certain DCI is associated with one RNTI” may mean that CRC parity bits of the DCI are scrambled with the RNTI. Referring to Table 8, some DCI may include scheduling information of one or more PUSCHs for a certain cell. For example, a CRC of the DCI format 0_1 may be scrambled with a C-RNTI, configured scheduling-RNTI (CS-RNTI), semi-persistent CSI RNTI (SP-CSI-RNTI), or modulation coding scheme cell RNTI (MCS-C-RNTI). The DCI format 0_1 may include at least one of the following information.
Identifier for DCI format (1 bit): Indicator indicating a UL DCI format, which is always set to 0 in the case of DCI format 0_1
Carrier indicator (0 or 3 bits): Indicator indicating a CC scheduled by the corresponding DCI
DFI flag (0 or 1 bit): Configured grant downlink feedback information (CG-DFI) indicator
If the DCI format 0_1 is used for CG-DFI indication (when the DFI flag is set to 1), at least one of the following fields may be used:
HARQ-ACK bitmap (16 bits), where the order of mapping HARQ process indexes within the bitmap is that the HARQ process indexes are mapped from the MSB to the LSB of the bitmap in ascending order. For each bit in the bitmap, a value of 1 indicates ACK, and a value of 0 indicates NACK.
TPC command for a scheduled PUSCH (2 bits)
All the remaining bits in the DCI format 0_1 are set to zero
If the DCI format 0_1 is not used for CG-DFI indication (when there is no DFI flag field or DFI flag field is set to 0), at least one of the following fields may be used:
UL/SUL indicator (0 or 1 bit): supplementary UL indicator.
Bandwidth part indicator (0, 1, or 2 bits): Indicator indicating a BWP to be activated among uplink BWPs configured for the terminal.
Frequency domain resource assignment: Indicator for allocating a frequency domain resource.
Time domain resource assignment: Indicator for allocating a time domain resource.
Frequency hopping flag (0 or 1 bit): Frequency axis hopping indicator
Modulation and coding scheme (5 bits)
New data indicator (NDI): Indicator indicating whether allocated data is new data or retransmission data.
Redundancy version (RV): Indicator indicating an RV value when channel coding is applied to allocated data
HARQ process number (4 bits): Indicator indicating a HARQ process to be allocated to scheduled data
TPC command for a scheduled PUSCH (2 bits): TPC indicator
SRS resource indicator: Aperiodic SRS resource selection indicator
Precoding information and number of layers: Indicator indicating precoding and the number of transport layers to be used in PUSCH transmission
Antenna ports: Indicator for uplink antenna ports to be used for PUSCH transmission
SRS request: Indicator indicating whether to transmit aperiodic SRS
CSI request: Indicator indicating whether and how to report channel state information
PTRS-DMRS association: Indicator indicating a relationship between an uplink phase-noise tracking reference signal (PTRS) antenna port and a demodulation reference signal (DMRS) antenna port
DMRS sequence initialization: Indicator for a DMRS sequence initialization value during OFDM-based uplink transmission
UL-SCH indicator: Indicator indicating whether or not an uplink shared channel (UL-SCH) is included in a PUSCH (a PUSCH that does not include a UL-SCH needs to include CSI)
Open-loop power control parameter set indication: Indicator indicating a set of open-loop power control (OPLC) parameter set
Priority indicator: Uplink transmission priority indicator
Invalid symbol pattern indicator: Indicator indicating whether to apply an invalid symbol pattern configured by a higher layer

As another example, a CRC of the DCI format 1_1 may be scrambled with a C-RNTI, CS-RNTI, or MCS-C-RNTI, and the DCI format 1_1 may include at least one of the following information.
Identifier for DCI format (1 bit): Indicator indicating a DL DCI format, which is always set to 1 in the case of DCI format 1_1
Carrier indicator (0 or 3 bits): Indicator indicating a CC scheduled by the corresponding DCI
Bandwidth part indicator (0, 1, or 2 bits): Indicator indicating a BWP to be activated among downlink BWPs configured for the terminal
Frequency domain resource assignment: Indicator for allocating a frequency domain resource
Time domain resource assignment: Indicator for allocating a time domain resource
PRB bundling size indicator: Indicator indicating a type (i.e., static or dynamic) and a size of PRB bundling
Rate matching indicator: Indicator indicating a rate matching pattern configured by a higher layer
ZP CSI-RS trigger: Indicator for applying aperiodic zero-power (ZP) CSI-RS
‘modulation and coding scheme’, ‘new data indicator’, and ‘redundancy version’ fields for a transport block 1
‘modulation and coding scheme’, ‘new data indicator’, and ‘redundancy version’ fields for a transport block 2
HARQ process number: Indicator indicating a HARQ process to be allocated to scheduled data
Downlink assignment index: DAI indicator for HARQ-ACK codebook generation in TDD operation
TPC command for a scheduled PUCCH: Power control indicator for PUCCH transmission
PUCCH resource indicator: Indicator indicating a PUCCH resource for transmitting HARQ-ACK information for an allocated PDSCH or a predetermined PDSCH set
PDSCH-to-HARQ_feedback timing indicator: Indicator indicating a time axis offset between the allocated PDSCH and the PUCCH
Antenna port(s): Indicator indicating antenna ports to be used for PDSCH transmission/reception
Transmission configuration indication: Indicator indicating transmission configuration information (TCI) to be used for PDSCH transmission and reception
SRS request: Indicator indicating whether to transmit aperiodic SRS
DMRS sequence initialization: Indicator for a DMRS sequence initialization value used for PDSCH transmission and reception
Priority indicator: PDSCH reception priority indicator

As another example, certain DCI formats may be used to deliver the same control information to one or more terminals. For example, a CRC of the DCI format 2_3 may be scrambled with a transmit power control-sounding reference signal-RNTI (TPC-SRS-RNTI), and may include at least one of the following information.
Block number 1, Block number 2, . . . , Block number B: Indicators indicating resource regions to which the DCI format 2_3 is applied. A starting part of the block is configured by a higher layer parameter starting BitOfFormat2-3 or startingBitOfFormat2-3SUL-v1530.
When a terminal for which a higher layer parameter srs-TPC-PDCCH-Group is set to type A performs uplink transmission without a PUCCH and PUSCH or uplink transmission in which SRS power control is not tied to PUSCH power control, one block is configured by the higher layer, and the following fields are defined for the block.
SRS request (0 or 2 bits): Aperiodic SRS transmission indicator
TPC command number 1, TPC command number 2, . . . , TPC command number N: Indicators indicating uplink power control to be applied to a UL carrier indicated by a higher layer parameter cc-IndexInOneCC-Set.
When a terminal for which a higher layer parameter srs-TPC-PDCCH-Group is set to type B performs uplink transmission without a PUCCH and PUSCH or uplink transmission in which SRS power control is not tied to PUSCH power control, one or more blocks may be configured by the higher layer, and the following fields are defined for each block.
SRS request (0 or 2 bits): Aperiodic SRS transmission indicator.
TPC command (2 bits)

The terminal may receive configuration information of a CORESET #0 and a search space #0, identical or similar to that shown in Table 9.

```
TABLE 9
PDCCH-ConfigSIB1 ::= SEQUENCE {
  controlResourceSetZero
  searchSpaceZero
}
ControlResourceSetZero // indicates a configuration value (0~15) of a CORESET #0 within an
initial BWP
SearchSpaceZero // indicates a configuration value (0~15) of a search space #0 within an
initial BWP
```

The terminal may refer to the following higher layer configurations for cell-specific PDCCH monitoring, identical or similar to those shown in Tables 10 to 13.

```
TABLE 10
PDCCH-ConfigCommon ::= SEQUENCE {
  controlResourceSetZero // indicates a configuration value (0~15) of a CORESET #0 within an
initial BWP
  commonControlResourceSet
      // configure a common CORESET by referring to CORESET configuration
searchSpaceZero // indicates a configuration value (0~15) of a search space #0 within an initial
BWP
  commonSearchSpaceList // configures a search sapce to be used for cell-specific PDCCH
monitoring by referring to up to four search space configurations
    searchSpaceSIB1 // search space configuration for SIB1
    searchSpaceOtherSystemInformation // search space configuration for SIB2 or other SIBs
    pagingSearchSpace // search space configuration for paging
  ra-SearchSpace // search space configuration for random access procedure
  ...
}
```

TABLE 11

| | |
|---|---|
| ControlResourceSet ::= | SEQUENCE { |

```
  controlResourceSetId // CORESET ID (a value other than 0 is used)
    frequencyDomainResources // configuration of frequency resources of a CORESET
  duration // configuration of a time-axis length (symbols) of a CORESET
```

| | |
|---|---|
| cce-REG-MappingType | CHOICE { // CCE-to-REG mapping configuration |
| interleaved | SEQUENCE { |

```
      reg-BundleSize
      interleaverSize
      shiftIndex
    },
    nonInterleaved
  },
  precoderGranularity
  tci-StatesPDCCH-ToAddList
        // indicates a QCL relation possible between a QCL reference RS and a PDCCH
DMRS
    tci-StatesPDCCH-ToReleaseList
  tci-PresentInDCI // indicates whether a TCI field exists within the DCI format 1_1
    pdcch-DMRS-ScramblingID // indicates a scrambling initialization value of a PDCCH DMRS
    ...
}
```

TABLE 12

| | |
|---|---|
| SearchSpace ::= | SEQUENCE { |

```
  searchSpaceId // search space ID
  controlResourceSetId // CORESET ID associated with the search space
monitoringSlotPeriodicityAndOffset CHOICE { // periodicity and offset of a PDCCH
monitoring slot
        sl1 // performs PDCCH monitoring in every slot
        ...
          // (omitted) monitoring offset values when a PDCCH monitoring periodicity
is one of 2 to 1280 slots
    sl2560 // a monitoring offset value when a PDCCH monitoring periodicity is 2560 slots
  }
  duration // the number of slots where a search space exists for each occasion

[symbol]

  monitoringSymbolsWithinSlot
      // a position of a first symbol on which monitoring is to be performed within a PDCCH
monitoring slot
```

| | |
|---|---|
| nrofCandidates | SEQUENCE { |

```
    aggregationLevel1 // The number of PDCCH candidates in case of aggregation level 1
        aggregationLevel2 // The number of PDCCH candidates in case of aggregation level 2
    aggregationLevel4 // The number of PDCCH candidates in case of aggregation level 4
    aggregationLevel8 // The number of PDCCH candidates in case of aggregation level 8
    aggregationLevel16 // The number of PDCCH candidates in case of aggregation level 16
  }
  searchSpaceType CHOICE { // indicates a search space type
```

TABLE 13

| (common or UE-specific) and DCI formats | |
|---|---|
| common | SEQUENCE { |

| dci-Format0-0-AndFormat1-0 | SEQUENCE { |
|---|---|
| ... | |
| } | |
| dci-Format2-0 | SEQUENCE { |
| nrofCandidates-SFI | SEQUENCE { |
| ... | |
| }, | |
| ... | |
| } | |
| dci-Format2-1 | |
| dci-Format2-2 | |
| dci-Format2-3 | SEQUENCE { |
| dummy1 | |
| dummy2 | |
| } | |
| }, | |
| ue-Specific | SEQUENCE { |

```
      dci-Formats
      ...,
    }
  }
}
```

The terminal may refer to the following higher layer configurations for UE-specific PDCCH monitoring, identical or similar to those shown in Table 14.

```
TABLE 14
PDCCH-Config ::= SEQUENCE {
  controlResourceSetToAddModList
      // At most three CORESETs are configured by referring to CORESET
configuration
    controlResourceSetToReleaseList
  searchSpacesToAddModList
      // At most ten search spaces are configured by referring to search space
configuration
searchSpacesToReleaseList
  downlinkPreemption // downlink preemption indicator
    tpc-PUSCH // configuraion of reception of a group TPC for PUSCH transmission
    tpc-PUCCH // configuration of reception of a group TPC for PUCCH transmission
    tpc-SRS // configuration of reception of a group TPC for SRS transmission
    ...,
}
```

The presence of one antenna port may mean a case in which a channel experienced by a symbol transmitted through the corresponding antenna port can be estimated or inferred from a channel experienced by another symbol transmitted through the same antenna port. “Two different antenna ports are quasi co-located (QCLed)” may mean a case in which large-scale characteristics of a channel experienced by a symbol transmitted through one antenna port can be estimated or inferred from a channel experienced by a symbol transmitted through another antenna port. The large-scale characteristics of the channel may mean at least one of ‘delay spread’, ‘Doppler spread’, ‘Doppler shift’, ‘average gain’, ‘average delay’, and ‘spatial Rx parameters’.

When time/frequency resources of a certain signal (e.g., QCL target RS) are insufficient and large-scale characteristics of a channel cannot be accurately measured with only the corresponding signal, information (i.e., QCL information) on another signal (e.g., QCL reference RS having sufficient time/frequency resources) having large-scale characteristics that can be reused for reception of the corresponding signal (i.e., QCL target RS) may be provided to the terminal to improve the channel measurement performance of the terminal. The NR communication system may support various QCL types as follows.
QCL-Type A: including {Doppler shift, Doppler spread, average delay, delay spread}.
QCL-Type B: including {Doppler shift, Doppler spread}
QCL-Type C: including {Doppler shift, average delay}
QCL-Type D: including {Spatial Rx parameters}

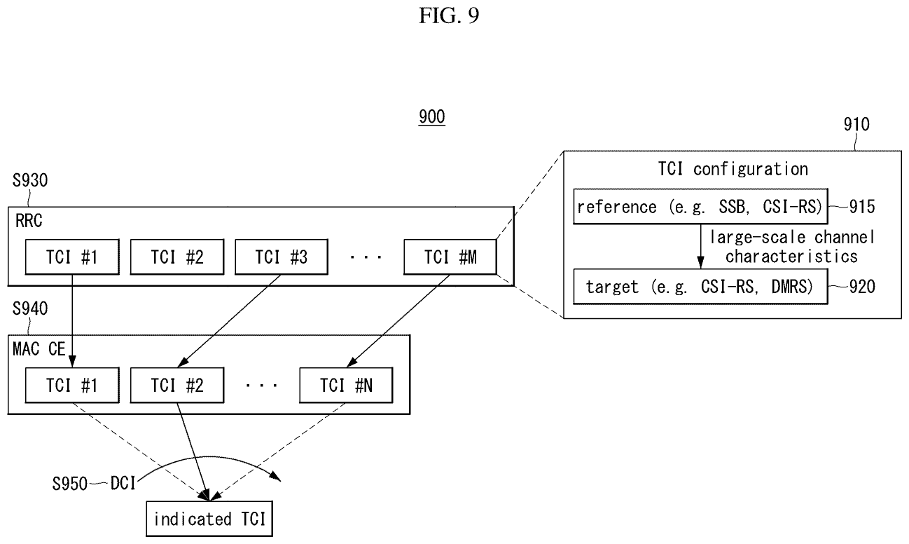

FIG. 9 is a conceptual diagram illustrating an exemplary embodiment of a QCL information transfer process through TCI state configuration and indication in a communication system.

Referring to FIG. 9, in a process of transmitting QCL information through TCI state configuration and indication in a communication system 900, a base station may configure at most M TCI states to a terminal through higher layer (i.e., RRC) signaling, in accordance with a UE capability report and a maximum value (e.g., 4, 8, 64, or 128 depending on a frequency band) defined in a technical specification (S930). In this case, each TCI state configuration 910 may include information on a signal or channel (i.e., QCL reference 915) that provides large-scale channel characteristics to a signal or channel (i.e., QCL target 920) referring to the TCI. One TCI state configuration 910 may include up to two references (i.e., qcl-Type1 and qcl-Type2), the first reference may be one of the QCL-Type A, QCL-Type B, and QCL-type C (i.e., qcl-type1∈{QCL-type A, QCL-type B, QCL-type C}), and the second reference may be the QCL-type D if present (i.e., qcl-type 2=QCL-type D).

Allowing the base station to apply all the TCIs configured through the RRC signaling in real time may greatly increase implementation complexity of the terminal, the base station may transmit an activation message for some of the TCIs configured through the RRC signaling to the terminal through L2 signaling such as a MAC CE (S940). The base station may activate a maximum of N (<M) TCIs, and the terminal may receive a dynamic indication only for the activated TCI.

Thereafter, the base station may dynamically indicate to the terminal some of the activated N TCIs through L1 signaling such as a DCI (S950). The terminal may apply QCL information indicated by the corresponding TCI at a predetermined timing after receiving the L1 signaling, and may perform a reception operation for the signal or channel.

The TCI state indication steps including the ‘RRC signaling (S930)’, ‘MAC CE signaling (S940)’, and ‘DCI signaling (S950)’ of FIG. 9 may be partially omitted depending on a type of the QCL target RS. For example, when the QCL target is a PDSCH DMRS, and one or more TCI states are configured through RRC signaling, the base station may indicate the TCI state using all the steps of FIG. 9. However, when the QCL target is a PDSCH DMRS, and a single TCI state is configured through RRC signaling, the MAC CE signaling (S940) and the DCI signaling step (S950) may be omitted. Similarly, when the QCL target is a PDCCH DMRS, the DCI signaling step S940 may be omitted. Specifically, the terminal may obtain configuration information for the TCI states and QCL information with reference to the RRC signaling identical or similar to those shown in Table 15.

TABLE 15

| | |
|---|---|
| TCI-State ::= | SEQUENCE { // TCI configuration (I.1-00) |

```
  tci-StateId // TCI state ID
  qcl-Type1 // first QCL reference configured by referring to QCL information
    qcl-Type2 // second QCL reference configured by referring to QCL information
  ...
}
```

| | |
|---|---|
| QCL-Info ::= | SEQUENCE { |

```
  cell // index of a cell in which QCL reference is transmitted
  bwp-Id // index of a BWP in which QCL reference is transmitted
```

| | |
|---|---|
| referenceSignal | CHOICE { |

```
    csi-rs // index of a CSI-RS to be referred when QCL reference is a CSI-RS
      ssb // index of an SSB to be referred when QCL reference is an SSB
  },
  qcl-Type
  // QCL type to be applied to a QCL target (one of QCL-type A, QCL-type B, QCL-type C, and
QCL-type D)
  ...
}
```

The base station may instruct the terminal to activate or deactivate some of the TCI states configured by the RRC signaling through MAC CE signaling, or may instruct the terminal to apply a TCI state indicated by a MAC CE to the QCL target RS. For example, the base station may use the following MAC CE signaling according to the type of the QCL target RS.
TCI state activation/deactivation MAC CE for a UE-specific PDSCH DMRS
TCI state indication MAC CE for a UE-specific PDCCH DMRS
TCI state activation/deactivation MAC CE for an enhanced UE-specific PDSCH DMRS

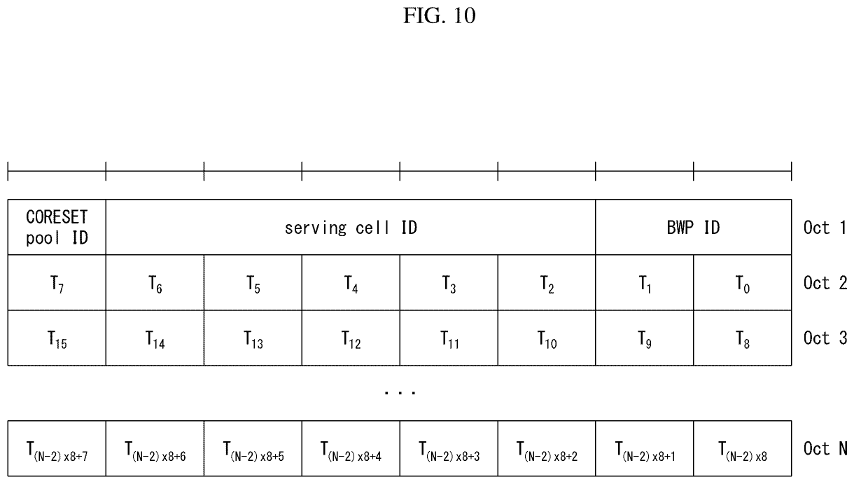

FIG. 10 is a conceptual diagram illustrating an exemplary embodiment of a TCI state activation/deactivation MAC CE in a communication system.

Referring to FIG. 10, a first octet (Oct 1) in a TCI state activation/deactivation MAC CE for a UE-specific PDSCH DMRS may include a COREST pool ID field 1010, a serving cell ID field 1020, and a BWP ID field 1030, and a second octet (Oct 2) to an N-th octet (Oct N) may include Ti fields 1040 indicating TCI state IDs i. The detailed meaning of each field may be as follows, and the sizes thereof may be variable.
Serving cell ID: a serving cell ID to which the MAC CE is applied
BWP ID: BWP ID to which the MAC CE is applied, which indicates a BWP in association with a BWP indication field within the DCI
Ti: indicates a TCI state ID i. When this value is set to 0, it may mean that a TCI state whose TCI state ID is i is deactivated, and when this value is set to 1, it may mean that a TCI state whose TCI state ID is i is activated. The TCI states activated by 1 may be sequentially mapped to TCI indication field code points within the DCI.
CORESET pool ID: If a DCI scheduling a PDSCH is monitored in a CORESET that does not include a higher layer parameter coresetPoolIndex, the field may be ignored. If a DCI scheduling a PDSCH is monitored in a CORESET including the higher layer parameter coresetPoolIndex, Ti indication may be applied only when a value of the CORESET pool ID matches a value of coresetPoolIndex of the CORESET.

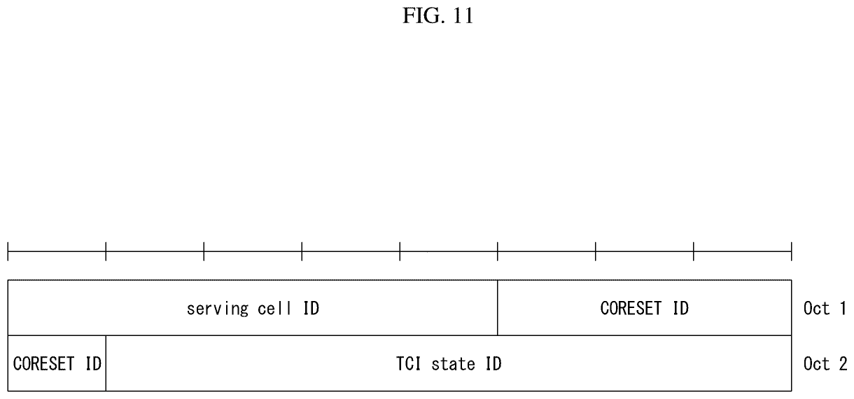

FIG. 11 is a conceptual diagram illustrating an exemplary embodiment of a TCI state indication MAC CE in a communication system.

Referring to FIG. 11, a first octet (Oct 1) in a TCI state activation/deactivation MAC CE for a UE-specific PDSCH DMRS may include a serving cell ID field 1110 and a CORESET ID field 1120, and a second octet (Oct 2) may include a CORESET ID field 1130 and a TCI state ID field 1140. The sizes thereof may be variable.
Serving cell ID: a serving cell ID to which the corresponding MAC CE is applied.
CORESET ID: indicates a CORESET to which the MAC CE is applied. If this value is set to 0, a CORESET configured through controlResourceSetZero may be a CORESET #0.
TCI state ID: means a TCI state ID indicated by the corresponding MAC CE.

The base station may configure spatial relation information to the terminal through higher layer (e.g., RRC) signaling in order to indicate uplink beam information. The spatial relation information may mean a signaling structure for using spatial domain filters used for transmission and reception of a reference RS for spatial TX filters for uplink transmission of a target RS according to the corresponding spatial relation. The spatial reference RS may be a downlink signal such as SSB or CSI-RS, and may also be an uplink signal such as SRS. If the reference RS is a downlink signal, the terminal may use the spatial RX filter values used for receiving the reference RS as spatial TX filter values for transmitting the target RS according to the spatial relation. If the reference RS is an uplink signal, the terminal may use the spatial TX filter values used for transmitting the reference RS as the spatial TX filter values for transmitting the target RS according to the spatial relation.

The signaling structure for the spatial relation information may vary depending on the type of target RS. For example, when the target RS is an SRS, the base station may perform RRC configuration for each SRS resource based on message identical or similar to those shown in Table 16.

TABLE 16

| | |
|---|---|
| SRS-SpatialRelationInfo ::= | SEQUENCE { |

servingCellId // index of a serving cell in which a reference RS is transmitted

| | |
|---|---|
| referenceSignal | CHOICE { |

```
    ssb-Index // SSB index when a reference RS is SSB
    csi-RS-Index // CSI-RS resource index when a reference RS is CSI-RS
```

| | |
|---|---|
| srs | SEQUENCE { |

```
      resourceId // SRS resource index when a reference RS is SRS
          uplinkBWP // index of a UL BWP in which SRS is transmitted when a reference
RS is SRS
        }
  }
}
```

For example, when the target RS is an SRS, the base station may perform RRC configuration for each SRS resource, identical or similar to those shown in Table 17.

TABLE 17

| | |
|---|---|
| PUCCH-SpatialRelationInfo ::= | SEQUENCE { |

```
  pucch-SpatialRelationInfoId // spatial relation information ID for PUCCH
  servingCellId // index of a serving cell in which a reference RS is transmitted
```

| | |
|---|---|
| referenceSignal | CHOICE { |

```
    ssb-Index // SSB index when a reference RS is SSB
    csi-RS-Index // CSI-RS resource index when a reference RS is CSI-RS
    srs // specifiy a SRS resource by referring to PUCCH-SRS configuration
},
  pucch-PathlossReferenceRS-Id
      // index of a RS resource to be used for measurement of a pathloss of a PUCCH
    p0-PUCCH-Id // index of confuring p0 for PUCCH power control
    closedLoopIndex // configuration value of closed-loop power control
}
PUCCH-SRS ::= SEQUENCE {
  resource // SRS resource index
  uplinkBWP // index of a BWP in which SRS is transmitted
}
```

In the 5G NR communication system, a slot format may include downlink symbol(s), uplink symbol(s), and/or flexible symbol(s).

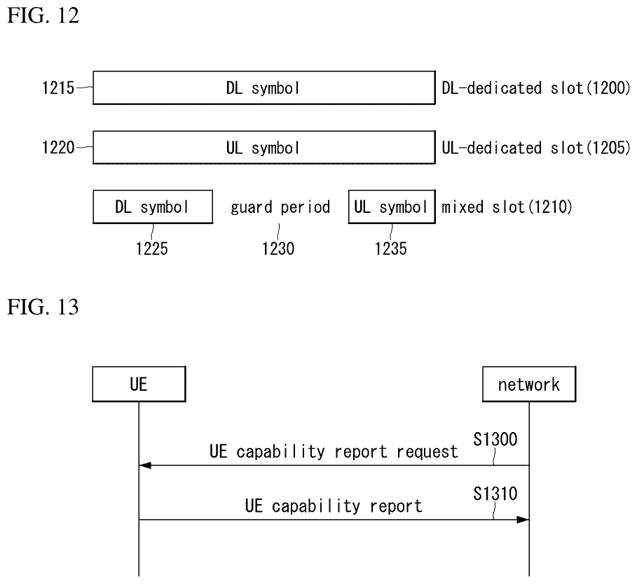

FIG. 12 is a conceptual diagram illustrating slot configurations according to slot formats in a communication system.

Referring to FIG. 12, in slot configurations according to slot formats in a communication system, a downlink dedicated slot 1200 may be a slot in which all symbols within the slot are configured only as downlink symbols 1215 according to a slot format. As another example, an uplink dedicated slot 1205 may be a slot in which all symbols within the slot are configured only as uplink symbols 1220 according to a slot format. As another example, in a downlink/uplink mixed slot 1210, some symbols within the slot may be configured as downlink symbols 1225, and some symbols within the slot may be configured as uplink symbols 1235 according to a slot format. In this case, specific symbols of the mixed slot 1210 including both the uplink and downlink symbols may be configured or indicated as a guard period 1230 for downlink-uplink switching, and the terminal may not perform transmission/reception during the guard period 1230.

In the 5G NR communication system, the base station may configure a ‘slot format’ over one or more slots for each serving cell to the terminal through a higher layer parameter tdd-UL-DL-ConfigurationCommon. In this case, the higher layer parameter tdd-UL-DL-ConfigurationCommon may include or refer to at least one of the following information.
Reference subcarrier spacing: reference numerology pref
Pattern 1: A first pattern.
Pattern 2: A second pattern.

Here, the pattern 1 or pattern 2 may include at least one of the following configurations.
Slot configuration periodicity (i.e., dl-UL-TransmissionPeriodicity): Slot configuration periodicity P expressed in units of msec
Number of downlink dedicated slots (i.e., nrofDownlinkSlots): The number dₛₗₒₜₛ of slots composed only of downlink symbols
Number of downlink symbols (i.e., nrofDownlinkSymbols): The number d_{sym} of downlink symbols
Number of uplink dedicated slots (i.e., nrofUplinkSlots): The number uₛₗₒₜₛ of slots composed only of uplink symbols
Number of uplink symbols (i.e., nrofUplinkSymbols): The number u_{sym} of uplink symbols

The slot configuration periodicity P msec of the first pattern may include S=P·2^{μ}^{_{ref}} slots, and in this case, the numerology may follow μ_{ref}. In addition, among the S slots, the first dₛₗₒₜₛ slots may include only downlink symbols, and the last uₛₗₒₜₛ slots may include only uplink symbols. In this case, d_{sym} symbols after first dₛₗₒₜₛ slots may be downlink symbols. In addition, u_{sym} symbols before last uₛₗₒₜₛ slots may be uplink symbols. The remaining symbols

$$( i . e . , ( S - {d}_{slots} - {u}_{slots} ) \cdot {N}_{s y m b}^{slot} - {d}_{s y m} - {u}_{s y m} symbols )$$

that are not designated as downlink symbols or uplink symbols in the pattern may be flexible symbols.

If the second pattern is configured and the slot configuration periodicity of the second pattern is P₂, a slot configuration periodicity P+P₂ msec configured with a combination of the first pattern and the second pattern may include first S=P·2^{μ}^{_{ref}} slots and second S₂=P₂·2^{μ}^{_{ref}} slots. In this case, the positions and numbers of downlink symbols, uplink symbols, and flexible symbols in the second pattern may be configured with reference to the description of the first pattern based on configuration information of the second pattern. In addition, when the second pattern is configured, the terminal may assume that P+P₂ is a divisor of 20 msec.

The base station may override direction(s) of ‘flexible symbol(s)’ among symbols configured through the higher layer parameter tdd-UL-DL-ConfigurationCommon by using the higher layer parameter tdd-UL-DL-ConfigurationDedicated) based on the following information.
Slot configuration set (i.e., slotSpecificConfigurationsToAddModList): A set of slot configurations
Slot index (i.e., slotIndex): An index of a slot included in the set of slot configurations
Symbol directions (i.e., symbols): The directions of the symbols indicated by the slot index (i.e., slotIndex). If all symbol directions are downlink (symbols=allDownlink), all symbols within the corresponding slot are downlink symbols. If all symbol directions are uplink (symbols=allUplink), all symbols within the corresponding slot are uplink symbols. If the symbol directions are explicit (symbols=explicit), nrofDownlinkSymbols may indicate the number of downlink symbols located in the first part of the corresponding slot, and nrofUplinkSymbols may indicate the number of uplink symbols located in the last part of the corresponding slot. If the nrofDownlinkSymbols or the nrofUplinkSymbols is omitted, the corresponding parameter may be regarded as indicating a value of 0. The remaining symbols within the slot become flexible symbols.

In the 5G communication system, the base station may indicate a slot format to the terminal based on L1 signaling. For example, when the terminal receives a higher layer parameter SlotFormatIndicator from the base station, the terminal may obtain configuration information a slot format indication-RNTI (i.e., SFI-RNTI). Meanwhile, when the terminal receives a higher layer parameter dci-PayloadSize from the base station, the terminal may obtain configuration information of a payload size of the DCI format 2_0. In addition, the terminal may additionally receive, from the base station, information on PDCCH candidate(s), CCE aggregation level, and search space set(s) of a CORESET for monitoring the DCI format 2_0. Each slot format indication (SFI) index field in the DCI format 2_0 may indicate a slot format to be applied to each slot in a slot set of a DL BWP and a UL BWP from a slot in which the terminal has detected the corresponding DCI format 2_0. In this case, the size of the slot set may be equal to or greater than a PDCCH monitoring periodicity of the DCI format 2_0. For example, when the slot set is composed of N slots, the DCI format 2_0 may include N SFI index fields, and each SFI index field may indicate a format value of Tables 18 to 20 below. In Tables 14 and 15, ‘D’ may mean a downlink symbol, ‘U’ may mean an uplink symbol, and ‘F’ may mean a flexible symbol.

TABLE 18

| Slot | Symbol number within a slot | | | | | | | | | | | | | |
|---|---|---|---|---|---|---|---|---|---|---|---|---|---|---|
| format | 0 | 1 | 2 | 3 | 4 | 5 | 6 | 7 | 8 | 9 | 10 | 11 | 12 | 13 |
| 0 | D | D | D | D | D | D | D | D | D | D | D | D | D | D |
| 1 | U | U | U | U | U | U | U | U | U | U | U | U | U | U |
| 2 | F | F | F | F | F | F | F | F | F | F | F | F | F | F |
| 3 | D | D | D | D | D | D | D | D | D | D | D | D | D | F |
| 4 | D | D | D | D | D | D | D | D | D | D | D | D | F | F |
| 5 | D | D | D | D | D | D | D | D | D | D | D | F | F | F |
| 6 | D | D | D | D | D | D | D | D | D | D | F | F | F | F |
| 7 | D | D | D | D | D | D | D | D | D | F | F | F | F | F |
| 8 | F | F | F | F | F | F | F | F | F | F | F | F | F | U |
| 9 | F | F | F | F | F | F | F | F | F | F | F | F | U | U |
| 10 | F | U | U | U | U | U | U | U | U | U | U | U | U | U |
| 11 | F | F | U | U | U | U | U | U | U | U | U | U | U | U |
| 12 | F | F | F | U | U | U | U | U | U | U | U | U | U | U |
| 13 | F | F | F | F | U | U | U | U | U | U | U | U | U | U |
| 14 | F | F | F | F | F | U | U | U | U | U | U | U | U | U |
| 15 | F | F | F | F | F | F | U | U | U | U | U | U | U | U |
| 16 | D | F | F | F | F | F | F | F | F | F | F | F | F | F |
| 17 | D | D | F | F | F | F | F | F | F | F | F | F | F | F |
| 18 | D | D | D | F | F | F | F | F | F | F | F | F | F | F |
| 19 | D | F | F | F | F | F | F | F | F | F | F | F | F | U |

TABLE 19

| Slot | Symbol number within a slot | | | | | | | | | | | | | |
|---|---|---|---|---|---|---|---|---|---|---|---|---|---|---|
| format | 0 | 1 | 2 | 3 | 4 | 5 | 6 | 7 | 8 | 9 | 10 | 11 | 12 | 13 |
| 20 | D | D | F | F | F | F | F | F | F | F | F | F | F | U |
| 21 | D | D | D | F | F | F | F | F | F | F | F | F | F | U |
| 22 | D | F | F | F | F | F | F | F | F | F | F | F | U | U |
| 23 | D | D | F | F | F | F | F | F | F | F | F | F | U | U |
| 24 | D | D | D | F | F | F | F | F | F | F | F | F | U | U |
| 25 | D | F | F | F | F | F | F | F | F | F | F | U | U | U |
| 26 | D | D | F | F | F | F | F | F | F | F | F | U | U | U |
| 27 | D | D | D | F | F | F | F | F | F | F | F | U | U | U |
| 28 | D | D | D | D | D | D | D | D | D | D | D | D | F | U |
| 29 | D | D | D | D | D | D | D | D | D | D | D | F | F | U |
| 30 | D | D | D | D | D | D | D | D | D | D | F | F | F | U |
| 31 | D | D | D | D | D | D | D | D | D | D | D | F | U | U |
| 32 | D | D | D | D | D | D | D | D | D | D | F | F | U | U |
| 33 | D | D | D | D | D | D | D | D | D | F | F | F | U | U |
| 34 | D | F | U | U | U | U | U | U | U | U | U | U | U | U |
| 35 | D | D | F | U | U | U | U | U | U | U | U | U | U | U |
| 36 | D | D | D | F | U | U | U | U | U | U | U | U | U | U |
| 37 | D | F | F | U | U | U | U | U | U | U | U | U | U | U |
| 38 | D | D | F | F | U | U | U | U | U | U | U | U | U | U |
| 39 | D | D | D | F | F | U | U | U | U | U | U | U | U | U |

TABLE 20

| Slot | Symbol number within a slot | | | | | | | | | | | | | |
|---|---|---|---|---|---|---|---|---|---|---|---|---|---|---|
| format | 0 | 1 | 2 | 3 | 4 | 5 | 6 | 7 | 8 | 9 | 10 | 11 | 12 | 13 |
| 40 | D | F | F | F | U | U | U | U | U | U | U | U | U | U |
| 41 | D | D | F | F | F | U | U | U | U | U | U | U | U | U |
| 42 | D | D | D | F | F | F | U | U | U | U | U | U | U | U |
| 43 | D | D | D | D | D | D | D | D | D | F | F | F | F | U |
| 44 | D | D | D | D | D | D | F | F | F | F | F | F | U | U |
| 45 | D | D | D | D | D | D | F | F | U | U | U | U | U | U |
| 46 | D | D | D | D | D | F | U | D | D | D | D | D | F | U |
| 47 | D | D | F | U | U | U | U | D | D | F | U | U | U | U |
| 48 | D | F | U | U | U | U | U | D | F | U | U | U | U | U |
| 49 | D | D | D | D | F | F | U | D | D | D | D | F | F | U |
| 50 | D | D | F | F | U | U | U | D | D | F | F | U | U | U |
| 51 | D | F | F | U | U | U | U | D | F | F | U | U | U | U |
| 52 | D | F | F | F | F | F | U | D | F | F | F | F | F | U |
| 53 | D | D | F | F | F | F | U | D | D | F | F | F | F | U |
| 54 | F | F | F | F | F | F | F | D | D | D | D | D | D | D |
| 55 | D | D | F | F | F | U | U | U | D | D | D | D | D | D |

| | |
|---|---|
| 56-254 | Reserved |
| 255 | UE determines a slot format of a slot based on a higher layer parameter tdd-UL-DL- |
| | ConfigurationCommon or a higher layer parameter tdd-UL-DL-ConfigurationDedicated, |
| | and a detected DCI format (when exists). |

Meanwhile, it may generally be impossible to force all terminals to implement the same features. The UE capability reporting may enable high-cost terminals to implement a large amount of features with high performance, and enable low-cost terminals to implement a small amount of features with low performance. The UE capability reporting can ensure a freedom of terminal implementation for various situations, and can also report the corresponding information to the network, allowing the base station to configure each function within the limits supported by each terminal. Specific functions may be promised to be mandatory for all terminals to implement, in which case it may be possible to omit UE capability reporting for those functions.

It may be possible for a terminal to report different values of UE capability for each frequency band or duplex scheme with respect to one function. For example, a terminal may report to the base station that it supports a specific function for a frequency range 1 (FR1), which refers to a band below 6 GHz, but does not support the function for a frequency range 2 (FR2), which refers to a band above 6 GHZ. As another example, a terminal may report to the base station that it supports a specific function in a TDD (e.g., unpaired spectrum) but does not support the function in a FDD (e.g., paired spectrum).

If a terminal performs UE capability reporting, the base station may need to respect (and not violate) the contents of the UE capability report when configuring, indicating, or scheduling the terminal. This means that if the base station indicates to the terminal configuration, indication, or scheduling which violates the UE capability report, the terminal may ignore it.

FIG. 13 is a sequence chart illustrating an exemplary embodiment of a UE capability reporting procedure in a communication system.

Referring to FIG. 13, in the UE capability reporting procedure, the base station may transmit a UE capability report request signal to the terminal through a higher layer parameter UECapabilityEnquiry when the terminal is in RRC connected mode (i.e., RRC_CONNECTED state) (S1300). In this case, the network may refer to only the UE capability report after access stratum (AS) security activation, and may not retransmit or report the UE capability report before the AS security activation to the core network (CN). Upon receiving the UE capability report request signal, the terminal may compile UE capability information according to a specific procedure, and report it to the base station through a UE capability information signal (e.g., UECapabilityInformation) (S1310).

The specific procedure for compiling the UE capability information signal may include a procedure of generating it least one of a list (i.e., supportedBandCombinationList) of band(s) or band combination(s) (BC(s)) supported by the terminal, feature set (FS) information related to feature sets supported by the terminal, or feature set combination (FSC) information related to feature set combinations supported by the terminal. For example, when the base station requests a UE capability report from the terminal in order to obtain information on band(s) or band combination(s) supported by the terminal, the terminal may report which band(s) it supports for each radio access technology (RAT). To this end, the base station may set a RAT-type in a UE RAT capability report request signal (e.g., UE-CapabilityRAT-Request), which is included in a UE RAT capability report request list signal (e.g., ue-CapabilityRAT-RequestList) that is a higher layer message, to one of ‘nr’, ‘eutra-nr’, ‘eutra’, and ‘eutra-fdd’. This may mean that the base station may request a UE capability report for one or more RATs or RAT combinations from the terminal, and in this case, the terminal may respond to each request for a list of support bands for a plurality of RATs or RAT combinations. For example, if the RAT-type is set to ‘nr’, the terminal may include a list of bands or band combinations to which NR-DC can be applied in the UE capability report. As another example, if the RAT-type is set to ‘eutra-nr’, the terminal may include a list of bands or band combinations applicable to multi-RAT DC (MR-DC) such as EN-DC, NGEN-DC, NE-DC, or the like in the UE capability report. In addition, when the base station requests a UE capability report, the base station may provide, to the terminal, a list of bands for which the terminal determines whether support is provided, through a higher layer parameter frequencyBandListFilter. For the bands included in the higher layer parameter frequencyBandListFilter, the terminal may determine a candidate band combination by considering ‘predetermined RAT types supported for each band’, ‘information on RAT-types requested by the base station’, etc., and may include the candidate band combination in the UE capability report.

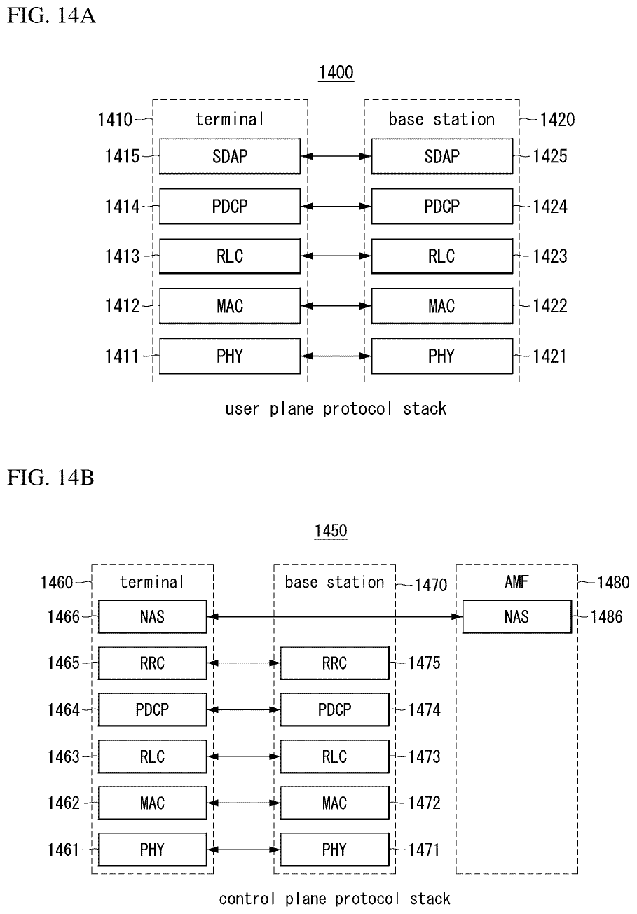

FIG. 14A is a conceptual diagram for describing a first exemplary embodiment of a user plane protocol stack structure in a communication system. FIG. 14B is a conceptual diagram for describing a first exemplary embodiment of a control plane protocol stack structure in a communication system.

Referring to FIGS. 14A and 14B, a radio interface protocol stack or radio interface protocol stack structures 1400 and 1450 may be defined in a radio connection section between communication nodes. For example, the radio interface protocol stack may be divided into a physical layer, a data link layer, a network layer, and the like, which are vertically configured.

The radio interface protocol stack may be divided into the user plane protocol stack 1400 and the control plane protocol stack 1450. Here, the control plane may be a plane for transmitting a control signal. The control signal may be referred to as a signaling signal. The user plane may be a plane for transmitting user data. Referring to FIG. 14A, the communication system may include a terminal 1410 and a base station 1420. The terminal 1410 may be referred to as a user equipment (UE). The base station 1420 may correspond to an eNB, a gNB, or the like. The terminal 1410 and the base station 1420 may perform mutual data signal transmission/reception based on the user plane protocol stack structure 1400 shown in FIG. 14A.

In the user plane air interface protocol stack structure 1400 of the communication system, the terminal 1410 and the base station 1420 may include PHY layers 1411 and 1421 included in L1, MAC layers 1412 and 1422, RLC layers 1413 and 1423, and packet data convergence protocol (PDCP) layers 1414 and 1424 included in L2, service data adaptation protocol (SDAP) layers 1415 and 1425 included in L3, and the like.

Referring to FIG. 14B, the communication system may include a terminal 1460 and a base station 1470. The terminal 1460 and the base station 1470 may perform mutual control signal transmission/reception based on the control plane protocol stack structure 1450 shown in FIG. 14B.

In the control plane protocol stack structure 1450 of the communication system, the terminal 1460 and the base station 1470 may include PHY layers 1461 and 1471 included in L1, MAC layers 1462 and 1472, RLC layers 1463 and 1473, and PDCP layers 1464 and 1474 included in L2, and RRC layers 1465 and 1475 included in L3, and the like.

The communication system may further include an Access and Management Mobility Function (AMF) 1480. In the control plane protocol stack structure 1450, the terminal 1460 and the AMF 1480 may include non-access stratum (NAS) layers 1466 and 1486. The base station 1470 may not include a NAS layer. In other words, in the control plane protocol stack structure 1450, the NAS layer of the base station 1470 may be transparent.

The 5G communication system can provide technologies for improving radio coverage and/or reducing network configuration costs. For example, the 5G communication system can provide integrated access and backhaul (IAB) technology that provides wireless backhaul/fronthaul that can coexist with a radio access network and repeater technology that covers shadow areas at low cost.

In the 5G NR communication system, it may be possible to support flexible and dense wireless backhaul links for each cell through the IAB feature, without support of a wired network.

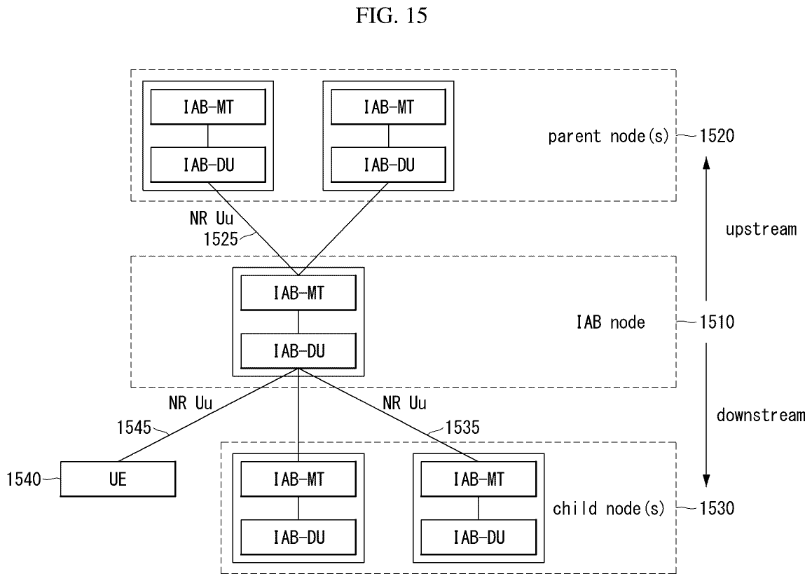

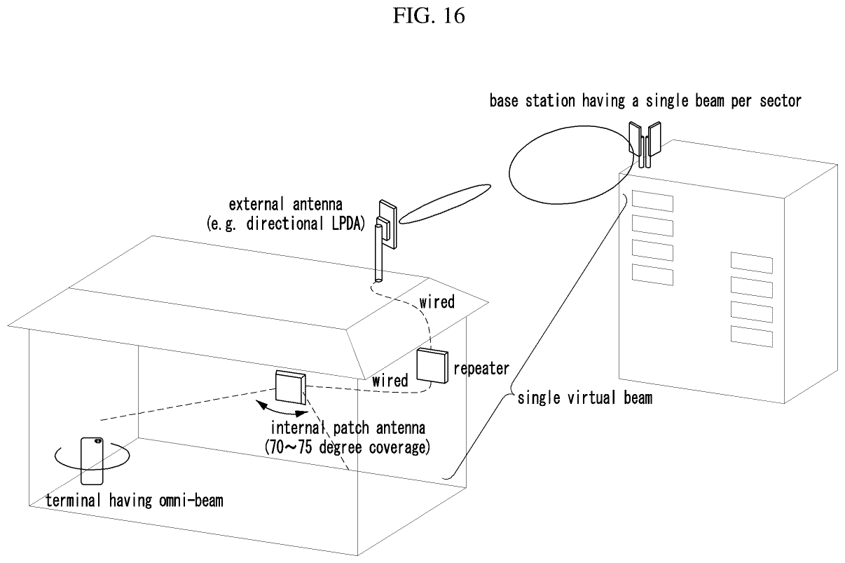

FIG. 15 is a conceptual diagram illustrating an exemplary embodiment of an IAB network in a communication system.

Referring to FIG. 15, a communication system 1500 may include one or more communication nodes. The communication nodes of the communication system 1500 may constitute an IAB network. For example, the communication system 1500 may include one or more IAB nodes. FIG. 15 shows an exemplary embodiment in which one IAB node communicates with one or more upper nodes and one or more lower nodes. However, this is merely an example for convenience of description, and exemplary embodiments of the present disclosure are not limited thereto.

The communication system 1500 may include a plurality of IAB nodes. For example, the communication system 1500 may include a first IAB node 1510, one or more parent nodes 1520 corresponding to upper nodes of the first IAB node 1510, and/or one or more child nodes 1530 corresponding to lower nodes of the first IAB node 1510. Here, each of the one or more parent nodes 1520 may be referred to as a ‘donor node’. The IAB node 1510, the one or more parent nodes 1520, and/or the one or more child nodes 1530 may constitute the IAB network. Each of the IAB nodes 1510, 1520, and 1530 constituting the IAB network may function as a type of repeater configured based on a front-haul structure. In the communication system 1500 to which the IAB network technology is applied, it is possible to support flexible and dense wireless backhaul links for each cell without support of a wired network.

Each of the IAB nodes 1510, 1520, and 1530 may include an IAB-DU and an IAB-MT. The IAB-MT may allow each IAB node to function as a terminal in communication with an upper node. For example, the first IAB node 1510 may communicate with the upper parent nodes 1520 through the IAB-MT. On the other hand, the IAB-DU may allow each IAB node to function as a base station or a cell in communication with a lower node. For example, the first IAB node 1510 may communicate with the lower child nodes 1530 or a terminal 1540 through the IAB-DU.

The IAB-MT of the first IAB node 1510 may be connected to the IAB-DUs of the parent nodes 1520 through Uu interfaces 1525. The IAB-DU of the first IAB node 1510 may be connected to the IAB-MTs of the child nodes 1530 through Uu interfaces 1535. The IAB-DU of the first IAB node 1510 may be connected to a terminal 1540 through a Uu interface 1545.

After the IAB node constituting the IAB network completely decodes a received signal, the IAB node may re-encode the decoded received signal, and amplify and transmit it. The IAB node may be classified as a type of regenerative relay. To this end, the IAB node may support a control plane (CP) and a user plane (UP) from the parent node to the terminal based on a protocol stack structure including the L1 and L2 layers, or higher layers.

The IAB node constituting the IAB network has an advantage of being able to perform various operations including operations as a base station and a terminal. On the other hand, the IAB node has disadvantages in that implementation complexity and production cost are relatively high, and a delay required for retransmission may be relatively large.

The radio frequency (RF) repeater may perform amplification and retransmission operations of received signals. The RF repeater may be a non-regenerative repeater.

FIG. 16 is a conceptual diagram illustrating a first exemplary embodiment of a commercial RF repeater.

Referring to FIG. 16, a commercial RF repeater may cover an indoor shadow area. The commercial RF repeater may include a first antenna (e.g., outdoor antenna) for receiving signals from a base station outdoors, a repeater for amplifying and retransmitting the received signals, and a second antenna (e.g., indoor patch antenna) for retransmitting the amplified signals indoors. The first antenna, repeater, and second antenna may be connected wired or wirelessly. The commercial RF repeater may operate in an FR1 band. In an FR1 band, the base station (e.g., eNB, gNB) may use one beam per cell or one sector.

In downlink communication, the first antenna may operate as a reception antenna and the second antenna may operate as a transmission antenna. In uplink communication, the first antenna may operate as a transmission antenna and the second antenna may operate as a reception antenna.

The first antenna may be a directional log-periodic dipole array (LPDA) antenna. The first antenna may be manually installed to face the base station. The second antenna that retransmits the amplified signals may be a patch antenna. An effective coverage of the second antenna may be approximately 70 to 75 degrees. The second antenna may support a terminal with omni-beam indoors.

The base station may recognize a beam of the base station, a beam of the first antenna of the commercial RF repeater, and a beam of the second antenna of the commercial RF repeater as one transmission beam. The one transmission beam may be a single virtual Tx beam. The base station may recognize a beam of the first antenna of the commercial RF repeater, a beam of the second antenna of the commercial RF repeater, and a beam of the terminal as one reception beam. The one reception beam may be a single virtual Rx beam.

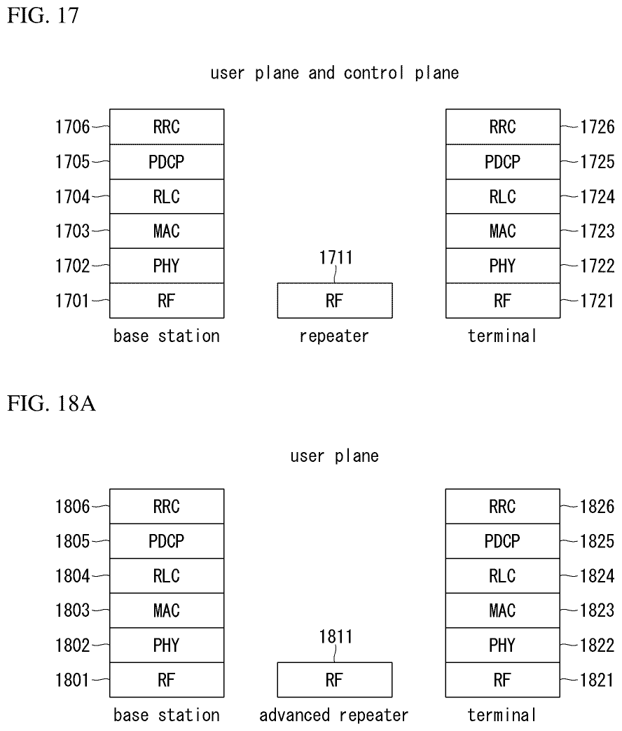

FIG. 17 is a conceptual diagram illustrating a first exemplary embodiment of protocol stacks of a control plane and a user plane in a communication system having an RF repeater.

Referring to FIG. 17, the base station and the terminal may each have PHY layers 1702 and 1722, MAC layers 1703 and 1723, RLC layers 1704 and 1724, PDCP layers 1705 and 1725, and RRC layers 1706 and 1726. The PHY layer may be a layer 1 (L1). The MAC layer, RLC layer, and PDCP layer may be a layer (L2). The RRC layer may be a layer (L3). The base station and the terminal may each transmit and receive signals through RFs 1701 and 1721. The RF repeater may not include a PHY layer, MAC layer, RLC layer, PDCP layer, and RRC layer. The RF repeater may include an RF 1711. The RF repeater may have a transparent functionality. The RF 1711 of the RF repeater may amplify signals and retransmit the amplified signals.

In the environment of FIGS. 16 and 17, the repeater (e.g., RF repeater) may simply repeatedly perform RF amplification/retransmission functions. The repeater that only performs RF amplification/retransmission functions may be referred to as an RF repeater. Therefore, the implementation complexity and cost of the RF repeater may be low. The base station and the network may not be able to secure control over the RF repeater. Therefore, it may be difficult to expect improvement in signal quality and control of the amount of interference through explicit management/indication/control and/or implicit management/indication/control of beams of the repeater.

The performance of the RF repeater may be limited in a time division duplexing (TDD) band that requires DL/UL switching and/or a frequency band (e.g., 3.5 GHz band or FR2 band) that requires multi-beam operations. In the 5G communication system, a direction (e.g., DL, UL, flexible (FL)) of slot(s) and/or symbol(s) may be dynamically indicated by L1 signaling (e.g., slot format configuration, slot format indication), and a beam/TCI/quasi-colocation (QCL) for each channel may be dynamically indicated. Since the RF repeater does not decode a transmission signal of the base station, it cannot recognize the indication.

To resolve the above-described problem, an advanced repeater capable of decoding a part or all of the base station's transmission signals may be considered. The advanced repeater may be referred to as a smart relay, enhanced relay, low-cost IAB node, network-controlled repeater (NCR), or NWC repeater.

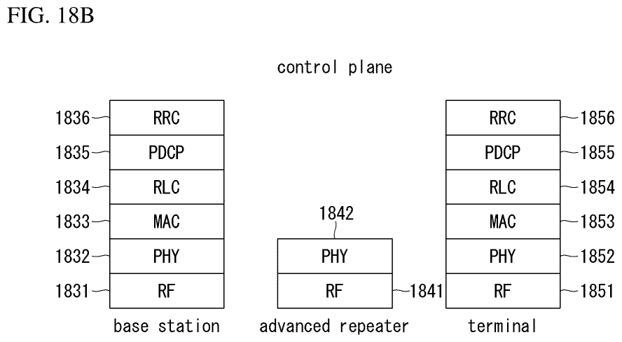

FIG. 18A is a conceptual diagram illustrating a first exemplary embodiment of a protocol stack of a user plane of an advanced repeater, and FIG. 18B is a conceptual diagram illustrating a first exemplary embodiment of a protocol stack of a control plane of an advanced repeater.

Referring to FIGS. 18A and 18B, the base station and the terminal may each have PHY layers 1802, 1822, 1832, and 1852, MAC layers 1803, 1823, 1833, and 1853, RLC layers 1804, 1824, 1834, and 1854, PDCP layers 1805, 1825, 1835, and 1855, and RRC layers 1806, 1826, 1836, and 1856. The base station and the terminal may each transmit and receive signals through RFs 1801, 1821, 1831, and 1851. The user plane of the advanced repeater may not include a PHY layer, MAC layer, RLC layer, PDCP layer, and RRC layer. The user plane of the advanced repeater may include an RF 1811. The user plane of the advanced repeater may have a transparent functionality. The RF 1811 of the advanced repeater may amplify signals and retransmit the amplified signals.

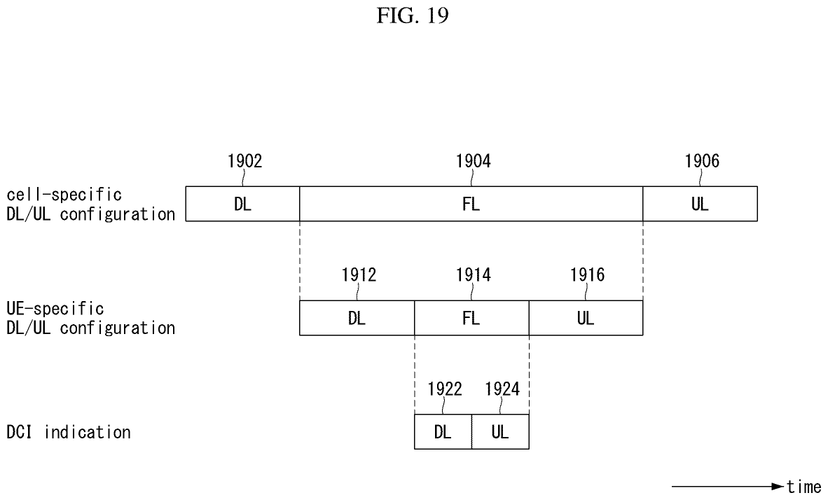

The control plane of the advanced repeater may include an RF 1841 and a PHY layer 1842. The RF 1841 may perform a transmission function. The PHY layer 1842 may be used for management and/or control of the advanced repeater. For example, the PHY layer 1842 may be used to manage and/or control beams, DL/UL configuration, slot format configuration, etc. of the advanced repeater. Additionally, the PHY layer 1842 may support a function of UE capability reporting. According to the PHY layer 1842 of the advanced repeater, management and/or control of beams, beam combinations, and/or slot formats may be supported for a link between the base station and the advanced repeater and/or a link between the advanced repeater and the terminal. The advanced repeater may support L2 function(s) and/or L3 function(s). FIG. 19 is a conceptual diagram illustrating a first exemplary embodiment of a slot format configuration method.

Referring to FIG. 19, a slot format within a time period may be configured by a cell-specific DL/UL configuration parameter (e.g., tdd-UL-DL-Configuration Common). According to the cell-specific DL/UL configuration parameters, a DL period 1902, FL period 1904, and UL period 1906 may be configured. The DL period 1902 may include DL symbol(s) and/or DL slot(s). The FL period 1904 may include FL symbol(s) and/or FL slot(s). The UL period 1906 may include UL symbol(s) and/or UL slot(s).

The FL period 1904 configured by the cell-specific DL/UL configuration parameter may be configured in detail by a UE-specific DL/UL configuration parameter (e.g., tdd-UL-DL-ConfigurationDedicated). According to the UE-specific DL/UL configuration parameter, the FL period 1904 may be reconfigured into a DL period 1912, FL period 1914, and UL period 1916. The DL period 1912 may include DL symbol(s) and/or DL slot(s). The FL period 1914 may include FL symbol(s) and/or FL slot(s). The UL period 1916 may include UL symbol(s) and/or UL slot(s).

The FL period 1914 configured by the cell-specific DL/UL configuration parameter and the UE-specific DL/UL configuration parameter may be configured in detail by DCI (e.g., DCI format 2_0, SFI). According to the DCI, the FL period 1914 may be reconfigured into a DL period 1922 and a UL period 1924. The DL period 1922 may include DL symbol(s) and/or DL slot(s). The UL period 1924 may include UL symbol(s) and/or UL slot(s).

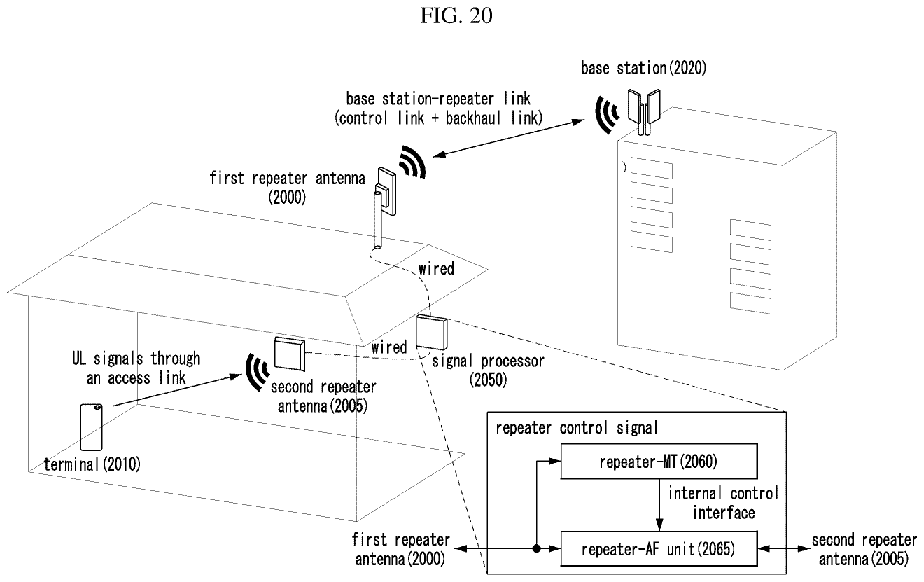

FIG. 20 is a conceptual diagram illustrating a first exemplary embodiment of NCR.

Referring to FIG. 20, an NCR 2050 may include one or more antennas or one or more antenna groups 2000 and 2005 that transmit and receive signals with communication nodes (e.g., base station 2020 and terminal 2010). In the present disclosure, ‘antenna group’ may be used with a meaning including ‘antenna’. An antenna group may be interpreted as an antenna, antenna group, or antenna panel depending on a context. The NCR may include a signal processor 2050, a first antenna group 2000 connected to the signal processor 2050, and a second antenna group 2005 connected to the signal processor 2050. The first antenna group 2000 may be referred to as a first repeater antenna. The first antenna group 2000 may perform a radio connection procedure with the base station 2020 in an outdoor environment. The second antenna group 2005 may be referred to as a second repeater antenna. The second antenna group 2005 may perform a radio connection procedure with the terminal 2010 in an indoor environment.

A base station-repeater link may include a control link through which a signal for the base station to control the repeater is transmitted and a backhaul link through which a signal for the base station to provide services to the terminal is transmitted. In the present disclosure, the base station-repeater link may refer to a link between the base station and a repeater, and the repeater may refer to the NCR (e.g., advanced repeater). A radio link between the repeater and the terminal may be an access link.

The signal processor 2050 of the NCR may include a repeater-mobile terminal (MT) 2060 and a repeater-amplify and forward (AF) unit 2065. The repeater-MT 2060 may receive a control signal from the base station and process the control signal. The repeater-AF unit 2065 may amplify a signal of the base station and retransmit the amplified signal. The repeater-MT 2060 and the repeater-AF unit 2065 may be connected to a radio link of the base station 2020 via the first antenna group 2000. The repeater-MT 2060 may receive control information (e.g., control signal) for the repeater from the first antenna group 2000, and indicate a control operation of the repeater based on the control information to the repeater-AF unit 2065 through an internal control interface. In the present disclosure, the control information may be RRC parameter, MAC CE, DCI, UCI, and/or side control information (SCI).

The repeater-AF unit 2065 may amplify a signal of the base station received from the first antenna group 2000 according to an indication, and retransmit the amplified signal to the terminal through the second antenna group 2005. Alternatively, the repeater-AF unit 2065 may amplify a signal of the terminal received from the second antenna group 2005 according to an indication, and retransmit the amplified signal to the base station through the first antenna group 2000.

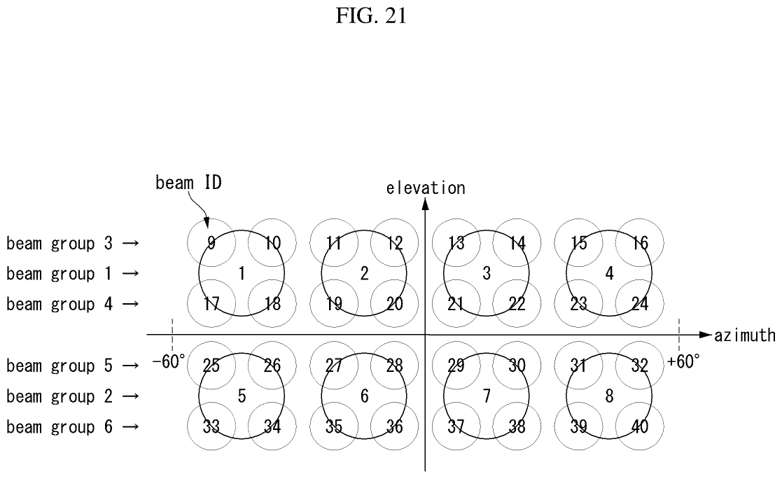

FIG. 21 is a conceptual diagram illustrating a first exemplary embodiment of a method for mapping a beam index (e.g., beam identifier (ID) to each beam at a repeater antenna.

Referring to FIG. 21, each of the first antenna 2000 and the second antenna 2005 of the repeater may include a plurality of antenna elements. One or more beams may be formed by multiplying one or more antenna elements by the same beam weights or different beam weights. A beam width of each of specific beams (e.g., beams #1 to #8) may be wider than that of other beams. Each of the beams #1 to #8 may be a wide beam or a coarse beam. The beam width of each of other specific beams (e.g., beams #9 to #40) may be narrower than a width of other beams. Each of the beams #9 to #40 may be a narrow beam, a fine beam, or a sharp beam.

One antenna or one antenna group may be able to form 40 beams, each of 8 beams among the 40 beams may be a wide beam, and each of 32 beams among the 40 beams may be a narrow beam. The number and shapes of beams formed by one antenna or one antenna group may vary.

A plurality of narrow beams (e.g., beams #9, #10, #17, and #18) may belong to a coverage of one wide beam (e.g., beam #1). To provide services to a terminal with high mobility and/or low data rate requirements, the base station may configure or indicate the second antenna 2005 of the repeater to use wide beam(s). To provide services to a terminal with low mobility and/or high data rate requirements, the base station may configure or indicate the second antenna 2005 of the repeater to use narrow beam(s).

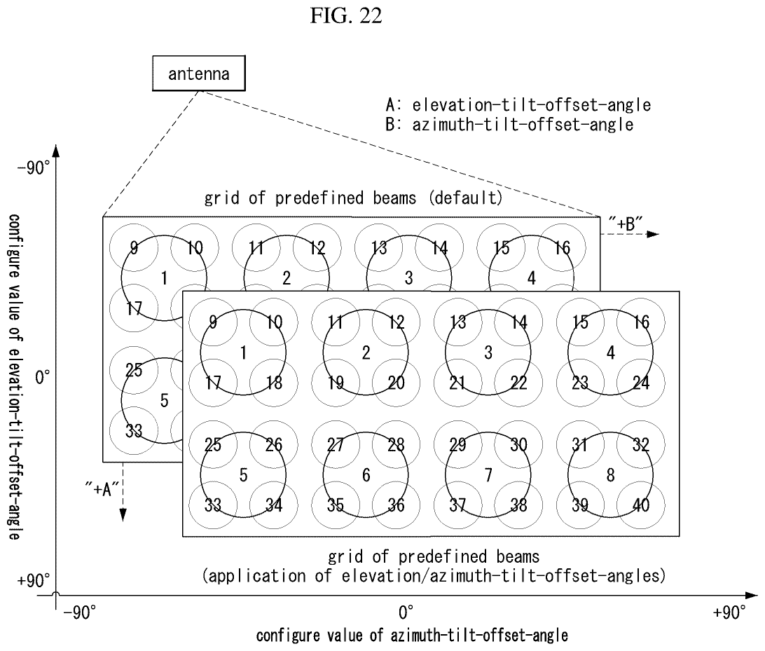

FIG. 22 is a conceptual diagram illustrating a first exemplary embodiment of a method for changing mapping of a beam index at a repeater antenna.

Referring to FIG. 22, there may be a basic beam-to-beam index mapping relationship defined for beams toward a front of an antenna from the perspective of the repeater's antenna (e.g., second antenna 2005 of the repeater). The front of the antenna may refer to a reference (i.e., boresight) direction. The front of the antenna may mean ‘0 degree azimuth and 0 degree elevation’. The basic beam-beam index mapping relationship may be a default grid of predefined beams. The basic beam-beam index mapping relationship may be the mapping relationship shown in FIG. 21.

A beam direction may be tilted by applying an offset A to an elevation direction and/or an offset B to an azimuth direction. The base station may configure or indicate the offset A and/or offset B to the repeater through signaling. The signaling may be at least one of SI signaling, RRC signaling, MAC signaling, or PHY signaling.

A very large capacity control channel may be required for the base station to control the repeater's beam(s) (e.g., the beam(s) shown in FIGS. 21 and/or 22). In the exemplary embodiments of FIG. 21 and/or FIG. 22, for indication of one beam among 40 beams, an indicator having a size of 6 bits for each beam may be required. When a 120 kHz subcarrier spacing (SCS) is used in the FR2 band, to support symbol-level beam indication granularity, indications for 112,000 time resources (e.g., symbols) may be required for each second based on Equation 5 below. The above-described overhead may occur due to the above indications. The overhead may increase linearly depending on the number of indicated beams or the number of subbands to which the indications are applied.

$$14 symbols \times 8 \frac{slot ( s )}{subframe} \times \frac{10 subframes}{frame ( 10 ms )} = 112 , 000 symbols / second \qquad [ Equation 5 ]$$

In the present disclosure, method(s) for solving the problem of signaling overhead for beam indications for the repeater will be described. Additionally, beam control method(s) of the repeater to perform efficient beam indications will be described. The present disclosure may be equally or similarly applied to exemplary embodiments in which the beams of the repeater are controlled by methods other than the beam index (e.g., QCL configuration, QCL index, TCI, TCI index).

The operations of the repeater-MT may be interpreted as the operations of the terminal. The operations based on the repeater's second antenna 2005 (e.g., second repeater antenna) will be described, and the operations may be applied equally or similarly to another antenna or group of antennas (e.g., repeater's first antenna 2000).

The base station may transmit a control signal (e.g., physical layer control signal) including control information for beam(s) of the second repeater antenna and/or the first repeater antenna. The repeater-MT may receive the control signal from the base station, and control the beam(s) of the second repeater antenna and/or the first repeater antenna based on the control signal. The physical layer control signal may be SCI and/or DCI.

### [First Exemplary Embodiment] Control Signaling Structure of Beam(s) of Repeater

Method(s) for the base station to indicate beam(s) of the second repeater antenna and/or beam(s) of the first repeater antenna to be used in a specific resource (e.g., specific time and/or frequency resource) will be described.

Control information (e.g., DCI, SCI) for controlling beam(s) of the repeater's antenna may include at least one information element among information elements defined in Table 21 below.

TABLE 21

| Information element | Description |
|---|---|
| Beam indication field | The beam indication field may indicate beam(s) used |
| | by the repeater antenna based on at least one of beam |
| | index(es), QCL index(es), TCI index(es), or spatial |
| | relation information index(es). The detailed |
| | description on the size of the beam indication field |
| | refers to the third exemplary embodiment. |
| Time resource indication | The time resource indication field may indicate a time |
| field | resource to which beam(s) indicated by the beam |
| | indication field are applied. |
| Frequency resource | The frequency resource indication field may indicate |
| indication field | a frequency resource to which beam(s) indicated by |
| | the beam indication field are applied. |
| Repeater antenna | The repeater antenna indication field may indicate a |
| indication field | repeater antenna, repeater antenna group, and/or |
| | repeater panel to which beam(s) indicated by the beam |
| | indication field are applied. The repeater antenna |
| | indication field may indicate information on the first |
| | repeater antenna and/or the second repeater antenna. |
| Beam management mode | The beam management mode indication field may |
| indication field | indicate a beam management mode. The beam |
| | management mode indication field may indicate |
| | whether to perform a beam sweeping operation based |
| | on indicated beams, beam group(s), or beam set(s). |
| | The beam management mode indication field may be |
| | referred to as a beam sweeping mode indication field. |
| | The detailed description on the beam management |
| | mode indication field refers to the second exemplary |
| | embodiment. |

The base station may generate control information (e.g., DCI format 2_8) including the information element(s) defined in Table 21 and transmit the control information to the repeater. The control information (e.g., CRC of the control information) may be scrambled by an NCR-RNTI. The repeater may receive the control information from the base station. The repeater may relay communication between the base station and the terminal based on the control information. For example, the repeater may relay communication between the base station and the terminal using beam(s) indicated by a beam indication field included in the control information. In addition, the repeater may use the beam(s) indicated by the beam indication field in time resource(s) indicated by a time resource indication field included in the control information and/or frequency resource(s) indicated by a frequency resource indication field included in the control information to relay communication between the base station and the terminal.

The beam(s) of the repeater used to relay communication between the base station and the terminal may be applied to antenna(s) indicated by an repeater antenna indication field included in the control information. When a beam management mode indication field included in the control information indicates to perform a beam sweeping operation, the repeater may relay communication between the base station and the terminal based on the beam sweeping operation.

Alternatively, the information element(s) defined in Table 21 may be included in a MAC CE, and the base station may transmit the MAC CE to the repeater. Alternatively, some information elements defined in Table 21 may be signaled through a MAC CE, and the remaining information elements defined in Table 21 may be signaled through a DCI.

The base station may configure time resource(s) (e.g., time resource list) for the repeater through signaling (e.g., SI signaling, RRC signaling, and/or MAC signaling). In this case, the time resource indication field included in the control information may indicate at least one time resource among the time resource(s) configured by the base station. Alternatively, the time resource indication field included in the control information may indicate at least one time resource belonging to the time resource list configured by the base station. The time resource indication field included in the control information may be configured as an index indicating at least one time resource among time resources preconfigured by the base station.

The base station may configure frequency resource(s) (e.g., frequency resource list) for the repeater to the repeater through signaling (e.g., SI signaling, RRC signaling, and/or MAC signaling). In this case, the frequency resource indication field included in the control information may indicate at least one frequency resource among the frequency resource(s) configured by the base station. Alternatively, the frequency resource indication field included in the control information may indicate at least one frequency resource belonging to the frequency resource list configured by the base station. The frequency resource indication field included in the control information may be configured as an index indicating at least one frequency resource among frequency resources preconfigured by the base station.

To reduce implementation costs and/or reduce implementation complexity, the repeater (e.g., repeater-MT) may support only some functions of the protocol stacks. In the repeater, functionality of some protocol stacks (e.g., non-access-stratum (NAS) protocol stack) may be omitted or limited. For example, there may be a repeater that can only receive a type-0 PDCCH. For example, if a bandwidth of CORESET0 is 24 PRBs, a payload size of the type-0 PDCCH that the repeater can receive may be 37 bits. If the bandwidth of CORESET0 is 48 PRBs, a payload size of the type-0 PDCCH that the repeater can receive may be 39 bits. If a bandwidth of CORESET0 is 96 PRBs, a payload size of the type-0 PDCCH that the repeater can receive may be 41 bits.

When a payload size for each beam of the beam indication field in the control information (e.g., DCI, SCI) is 6 bits, Table 22 shows the possible payload sizes of the time resource indication field according to the number of beams indicated by the control information. When the payload size for each beam of the beam indication field in the control information is 5 bits, Table 23 shows the possible payload sizes of the time resource indication field according to the number of beams indicated by the control information. The payload of the time resource indication field may be a payload for slot/symbol allocation.

Identically as Type-0 PDCCH, it may be assumed in Tables 22 and 23 that the control information (e.g., DCI, SCI) includes 15 reserved bits. In this case, the same receiver for the Type-0 PDCCH can be used. Table 22 and Table 23 may be applied to the frequency resource indication field in control information. In other words, Table 22 and Table 23 may be applied to the time/frequency resource indication field in the control information. The time/frequency resource indication field may mean ‘time resource indication field’, ‘frequency resource indication field’, or ‘time resource indication field and frequency resource indication field’. The time resource indication field may be a time domain resource assignment (TDRA), and the frequency resource indication field may be a frequency domain resource assignment (FDRA).

TABLE 22

| | | Payload size | | |
|---|---|---|---|---|
| Payload size | | (bits) for | | Total |
| (bits) per | Number of | slot/symbol | Reserved | payload size |
| beam | beams | allocation | bits | (bits) |
| 6 | 1 | 16 | 15 | 37 |
| 6 | 2 | 10 | 15 | 37 |
| 6 | 3 | 4 | 15 | 37 |
| 6 | 4 | −2 | 15 | 37 |
| 6 | 1 | 18 | 15 | 39 |
| 6 | 2 | 12 | 15 | 39 |
| 6 | 3 | 6 | 15 | 39 |
| 6 | 4 | 0 | 15 | 39 |
| 6 | 1 | 20 | 15 | 41 |
| 6 | 2 | 14 | 15 | 41 |
| 6 | 3 | 8 | 15 | 41 |
| 6 | 4 | 2 | 15 | 41 |

TABLE 23

| | | Payload size | | |
|---|---|---|---|---|
| Payload size | | (bits) for | | Total |
| (bits) per | Number of | slot/symbol | Reserved | payload size |
| beam | beams | allocation | bits | (bits) |
| 5 | 1 | 17 | 15 | 37 |
| 5 | 2 | 12 | 15 | 37 |
| 5 | 3 | 7 | 15 | 37 |
| 5 | 4 | 2 | 15 | 37 |
| 5 | 1 | 19 | 15 | 39 |
| 5 | 2 | 14 | 15 | 39 |
| 5 | 3 | 9 | 15 | 39 |
| 5 | 4 | 4 | 15 | 39 |
| 5 | 1 | 21 | 15 | 41 |
| 5 | 2 | 16 | 15 | 41 |
| 5 | 3 | 11 | 15 | 41 |
| 5 | 4 | 6 | 15 | 41 |

Based on Table 22 and Table 23, the possible size of the payload of the time/frequency resource indication field may be mostly 0 to 20 bits. In this case, one or more of the methods below may be used to specify a time and/or frequency resource to which the indicated beam is applied.
Method 1: At least one of a start point (e.g., start slot and/or start symbol), end point (e.g., end slot and/or end symbol), or length (e.g., length/number of consecutive slots and/or length/number of consecutive symbols) of a time resource may be explicitly indicated.
Method 2: Each bit included in a bitmap may indicate whether to apply to a representative start resource (e.g., one or more slots and/or one or more symbols).

Method 1 may be applied to a second time/frequency resource indication field described later, and Method 2 may be applied to a first time/frequency resource indication field described later. Alternatively, either Method 1 or Method 2 may be applied to the first time/frequency resource indication field, and either Method 1 or Method 2 may be applied to the second time/frequency resource indication field.

If the same reserved bits as the Type-0 PDCCH (e.g., 15 bits per SCI) are not assumed, Table 22 may be modified as Table 24 below, and Table 23 may be modified as Table 25 below.

TABLE 24

| | | Payload size | | |
|---|---|---|---|---|
| Payload size | | (bits) for | | Total |
| (bits) per | Number of | slot/symbol | Reserved | payload size |
| beam | beams | allocation | bits | (bits) |
| 6 | 1 | 20 | 11 | 37 |
| 6 | 2 | 20 | 5 | 37 |
| 6 | 3 | 10 | 9 | 37 |
| 6 | 4 | 10 | 3 | 37 |
| 6 | 1 | 20 | 13 | 39 |
| 6 | 2 | 20 | 7 | 39 |
| 6 | 3 | 20 | 1 | 39 |
| 6 | 4 | 10 | 5 | 39 |
| 6 | 1 | 20 | 15 | 41 |
| 6 | 2 | 20 | 9 | 41 |
| 6 | 3 | 20 | 3 | 41 |
| 6 | 4 | 10 | 7 | 41 |

TABLE 25

| | | Payload size | | |
|---|---|---|---|---|
| Payload size | | (bits) for | | Total |
| (bits) per | Number of | slot/symbol | Reserved | payload size |
| beam | beams | allocation | bits | (bits) |
| 5 | 1 | 20 | 12 | 37 |
| 5 | 2 | 20 | 7 | 37 |
| 5 | 3 | 20 | 2 | 37 |
| 5 | 4 | 10 | 7 | 37 |
| 5 | 1 | 20 | 14 | 39 |
| 5 | 2 | 20 | 9 | 39 |
| 5 | 3 | 20 | 4 | 39 |
| 5 | 4 | 10 | 9 | 39 |
| 5 | 1 | 20 | 16 | 41 |
| 5 | 2 | 20 | 11 | 41 |
| 5 | 3 | 20 | 6 | 41 |
| 5 | 4 | 20 | 1 | 41 |

If a sufficient size of the payload is secured as shown in Table 24 and Table 25 (e.g., when (size of a payload for slot/symbol allocation+number of reserved bits' is equal to or greater than 3, a time/frequency resource indication field including two parts may be used. For example, a time/frequency resource indication field may include a first time/frequency resource indication field (e.g., first part) and a second time/frequency resource indication field (e.g., second part). According to the time/frequency resource indication field, resources may be indicated in more detail.

Tables 26 and 27 below may indicate a time/frequency resource indication field including the first time/frequency resource indication field and the second time/frequency resource indication field. The first time/frequency resource indication field may indicate whether to apply a beam to a long time period (e.g., slot, slot group, consecutive slots) and/or a wide frequency region based on a bitmap. The second time/frequency resource indication field may indicate whether to apply a beam to a short time period (e.g., symbol, symbol pattern, symbol group, consecutive symbols) or a narrow frequency range based on a predefined pattern (e.g., start and length indication value (SLIV)).

The base station may indicate to the repeater (e.g., repeater-MT) whether to apply a beam in units of symbols with respect to the entire time period based on a combination of the first time/frequency resource indication field and the second time/frequency resource indication field. Table 26 may show a case where the same 5 time/frequency resource indication field is applied to all beams indicated by control information. Table 27 may show a case where different time/frequency resource fields (e.g., different second time/frequency resource indication fields) are applied to the respective beams indicated by control information.

TABLE 26

| | | Size (bits) | Size (bits) | | |
|---|---|---|---|---|---|
| Payload | | of slot | of symbol | | Total |
| size (bits) | Number of | indicator | indicator | Reserved | payload |
| per beam | beams | (bitmap) | (SLIV) | bits | size (bits) |
| 6 | 1 | 20 | 4 | 7 | 37 |
| 6 | 2 | 20 | 4 | 1 | 37 |
| 6 | 3 | 10 | 4 | 5 | 37 |
| 6 | 4 | 9 | 4 | 0 | 37 |
| 6 | 1 | 20 | 4 | 9 | 39 |
| 6 | 2 | 20 | 4 | 3 | 39 |
| 6 | 3 | 10 | 4 | 7 | 39 |
| 6 | 4 | 10 | 4 | 1 | 39 |
| 6 | 1 | 20 | 4 | 11 | 41 |
| 6 | 2 | 20 | 4 | 5 | 41 |
| 6 | 3 | 10 | 4 | 9 | 41 |
| 6 | 4 | 10 | 4 | 3 | 41 |

TABLE 27

| | | Size (bits) | Size (bits) | | |
|---|---|---|---|---|---|
| Payload | | of slot | of symbol | | Total |
| size (bits) | Number of | indicator | indicator | Reserved | payload |
| per beam | beams | (bitmap) | (SLIV) | bits | size (bits) |
| 6 | 1 | 20 | 4 | 7 | 37 |
| 6 | 2 | 10 | 8 | 7 | 37 |
| 6 | 3 | 5 | 12 | 2 | 37 |
| 6 | 4 | −3 | 16 | 0 | 37 |
| 6 | 1 | 20 | 4 | 9 | 39 |
| 6 | 2 | 10 | 8 | 9 | 39 |
| 6 | 3 | 5 | 12 | 4 | 39 |
| 6 | 4 | −1 | 16 | 0 | 39 |
| 6 | 1 | 20 | 4 | 11 | 41 |
| 6 | 2 | 20 | 8 | 1 | 41 |
| 6 | 3 | 10 | 12 | 1 | 41 |
| 6 | 4 | 0 | 16 | 1 | 41 |

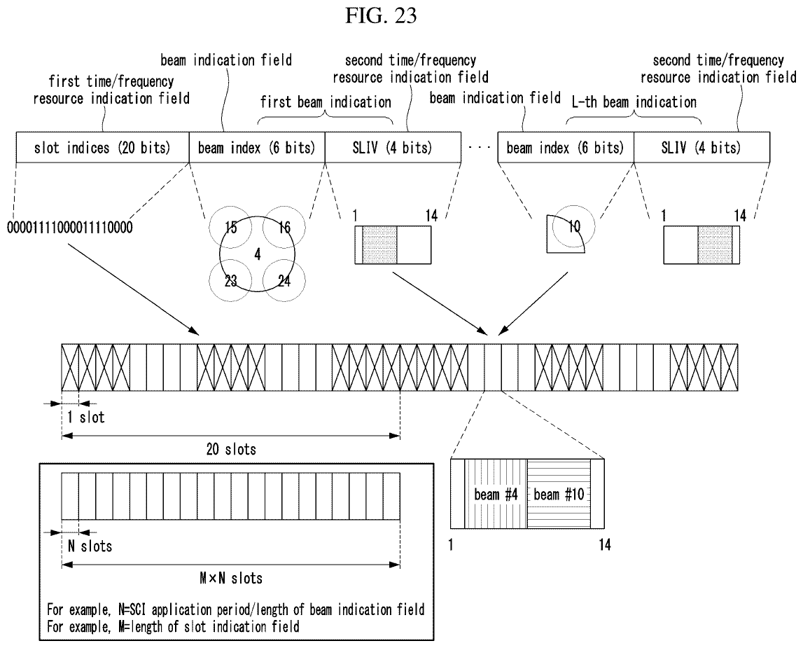

FIG. 23 is a conceptual diagram illustrating a first exemplary embodiment of a beam indication of a repeater and a beam allocation result according to the beam indication.

Referring to FIG. 23, control information (e.g., DCI, SCI) transmitted by a communication node (e.g., base station) may include a pair(s) of [first time/frequency resource indication field (e.g., slot indices), L beam indication fields, L second time/frequency resource indication fields (e.g., SLV)] commonly applied to all beams indicated by the control information. L may be a natural number greater than or equal to 1. The arrangement order of the fields may be configured in various ways. Bits of the first time/frequency resource indication field may indicate whether to apply a beam to N slots. N may be a natural number greater than or equal to 1. For example, a bit set to a first value (e.g., 0) may indicate non-application of the beam or prohibition of retransmission of the repeater in slot(s) corresponding to the bit. A bit set to a second value (e.g., 1) may indicate application of the beam or allowing retransmission of the repeater in slot(s) corresponding to the bit.

The entire bit sequence of the first time/frequency resource indication field may indicate whether to apply a beam to NλM slots. Whether or not a beam is applied may mean a beam application pattern. M may be the number of bits of the first time/frequency resource indication field. N may be a value obtained by dividing the entire period (e.g., the number of slots or symbols corresponding to the entire period) to which the control information (e.g., SCI) is applied by M. In other words, N may be the number of slots represented by a bit of the first time/frequency resource indication field.

When the first beam indication field indicates a beam #4, the second time/frequency resource indication field corresponding to the first beam indication field indicates symbols #2 to #7 within a slot, the second beam indication field Indicates a beam #10, and the second time/frequency resource indication field corresponding to the second beam indication field indicates symbols #8 to #13 within the slot, the beams #4 to #10 may be sequentially used within the slot to which the beam indication is applied.

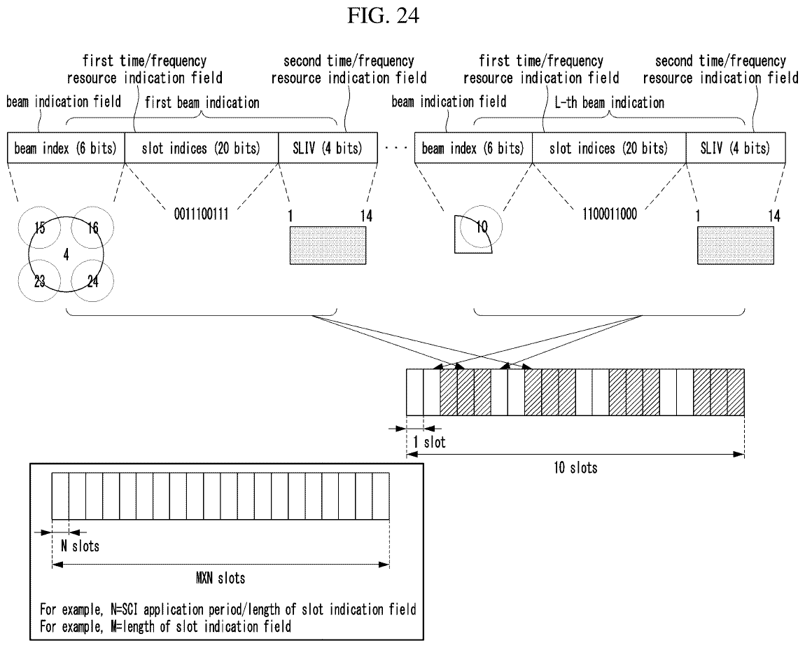

FIG. 24 is a conceptual diagram illustrating a second exemplary embodiment of a beam indication of a repeater and a beam allocation result according to the beam indication.

Referring to FIG. 24, control information (e.g., DCI, SCI) transmitted by a communication node (e.g., base station) may include a pair(s) of [L beam indication fields, L first time/frequency resource indication fields (e.g., slot indices), L second time/frequency resource indication fields (e.g., SLIVs)]. L may be a natural number greater than or equal to 1. The arrangement order of the fields may be configured in various ways. Bits of the first time/frequency resource indication field may indicate whether to apply a beam to N slots. N may be a natural number greater than or equal to 1. For example, a bit set to a first value (e.g., 0) may indicate non-application of a beam or prohibition of retransmission of the repeater in slot(s) corresponding to the bit. A bit set to a second value (e.g., 1) may indicate application of a beam or allowing retransmission of the repeater in slot(s) corresponding to the bit.

The entire bit sequence of the first time/frequency resource indication field may indicate whether to apply a beam to N×M slots. Whether or not a beam is applied may mean a beam application pattern. M may be the number of bits of the first time/frequency resource indication field. N may be a value obtained by dividing the entire period (e.g., the number of slots or symbols corresponding to the entire period) to which the control information (e.g., DCI or SCI) is applied by M. In other words, N may be the number of slots represented by a bit of the first time/frequency resource indication field.

When the first beam indication field indicates a beam #4, the first time/frequency resource indication field corresponding to the first beam indication field indicates slots #2, #3, #4, #7, #8, and #9, the second beam indication field Indicates a beam #10, and the first time/frequency resource indication field corresponding to the second beam indication field indicates slots #0, #1, #5, and #6, different beams may be applied in the respective slots.

### [Second Exemplary Embodiment] Method for Configuring a Beam Sweeping Field of Repeater

In a second exemplary embodiment, method(s) for a base station to indicate a management mode of beams of the second repeater antenna (or beams of the first repeater antenna) to be used in a specific time and/or frequency resource will be described. The management mode may mean a beam sweeping mode.

In the first exemplary embodiment, methods for the base station to indicate a beam (e.g., beam index, QCL index, TCI index) or beam group to be applied to the repeater antenna have been described. In the first exemplary embodiment, a beam or beam group may be directly indicate. The use of the first exemplary embodiment (e.g., method of directly indicating a beam or beam group) may not be easy in an initial access procedure, radio link failure recovery procedure, and/or beam failure recovery procedure. In other words, when the base station cannot use channel quality information for each beam, use of the first exemplary embodiment may not be easy.

In an environment where the base station cannot use channel quality information for each beam, it may be preferable to perform a beam sweeping operation on the entire set or a subset of available beams of the repeater antenna. For the above-described operation, control information (e.g., DCI, SCI) may include a beam management mode indication field. The beam management mode indication field may include one or more bits. The beam management mode indication field may be referred to as a beam sweeping mode indication field.

If a value of the beam sweeping mode indication field in the control information (e.g., DCI, SCI) received by the repeater is set to a first value (e.g., 0 or 1), the repeater may not perform a beam sweeping operation. If a value of the beam sweeping mode indication field in the control information (e.g., SCI) received by the repeater is set to a second value (e.g., 1 or 0), the repeater may perform a beam sweeping operation.

A beam group used in the beam sweeping operation may include all beams applicable to the repeater antenna, beams selected by the repeater within a number set or indicated by the base station among all beams applicable to the repeater antenna, beams reported by the repeater to the base station among the beams selected by the repeater within a number set or indicated by the base station among all beams applicable to the repeater antenna, or beams (e.g., beams index(es), QCL index(es), TCI index(es)) configured or indicated by the base station among all beams applicable to the repeater antenna. The beam sweeping operation may be performed in separately configured time/frequency resources or separately indicated time/frequency resources.

The beam sweeping mode indication field in the control information (e.g., DCI, SCI) may indicate whether to perform a beam sweeping operation for uplink communication in an access link/forward link. For example, the beam sweeping mode indication field in the control information may indicate whether to perform a reception beam sweeping operation on signals transmitted from the terminal to the repeater. In this case, the beam sweeping operation according to the beam sweeping mode indication field may be defined as being performed in all or part of configured uplink resources (or indicated uplink resources). Alternatively, the base station may configure that the beam sweeping operation according to the beam sweeping mode indication field is performed in all or part of configured uplink resources (or indicated uplink resources).

The some uplink resources for the uplink beam sweeping operation of the second repeater antenna may be specific time/frequency resources (e.g., SRS, PRACH, PUCCH, PUSCH, and/or PUSCH for the repeater-MT) configured or indicated to the repeater-MT. Based on the above-described operation, the base station may perform an efficient beam sweeping operation for the second repeater antenna.

The beam sweeping mode indication field in the control information (e.g., SCI) may indicate whether to perform a beam sweeping operation for downlink communication in an access link/forward link. For example, the beam sweeping mode indication field in the control information may indicate whether to perform a transmission beam sweeping operation on signals transmitted from the repeater to the terminal. In this case, the beam sweeping operation according to the beam sweeping mode indication field may be defined as being performed in all or part of configured downlink resources (or indicated downlink resources). Alternatively, the base station may configure that the beam sweeping operation according to the beam sweeping mode indication field is performed in all or part of configured downlink resources (or indicated downlink resources).

The some downlink resources for the downlink beam sweeping operation of the second repeater antenna may be specific time/frequency resources (e.g., SSB resource, CSI-RS resource, PDCCH resource, PDSCH resource, and/or PDSCH resource for the repeater-MT) configured or indicated to the repeater-MT. Based on the above-described operation, the base station may indicate the terminal to perform channel state reporting for different beams of the second repeater antenna.

### [Third Exemplary Embodiment] Method for Determining the Size of the Beam Indication Field of the Repeater

In the third exemplary embodiment, methods for determining the size (e.g., payload size) of the beam indication field in the control information (e.g., DCI, SCI) will be described.

The size of the beam indication field in the control information may be determined based on capability reporting signaling of the repeater-MT. For example, the repeater may report repeater-MT capability including information on the number N_{repeater-RU} of beams supported by the second repeater antenna (or first repeater antenna) to the base station. In this case, the size of the beam indication field for each beam may be defined based on B_{BI}=log₂└N_{repeater-RU}┘. B_{BI} may be the size of the beam indication field for each beam. A unit of BBI may be a bit. When one piece of control information indicates L beams, there are L beam indication fields in the control information, so the total payload size of the L beam indication fields may be L×B_{BI}.

The size of the beam indication field in the control information may be determined based on higher layer signaling. For example, when the repeater reports repeater-MT capability including information on the number N_{repeater-RU} of beams supported by the second repeater antenna (or first repeater antenna) to the base station, the base station may allocate M_{repeater-RU} beams, where M_{repeater-RU} is equal to or less than N_{repeater-RU}, to the second repeater antenna (or first repeater antenna). That is, M_{repeater-RU} may be equal to or less than N_{repeater-RU}. In this case, the size of the beam indication field for each beam may be defined based on B_{BI}=log₂ └M_{repeater-RU}┘. When one piece of control information indicates L beams, there are L beam indication fields in the control information, so the total payload size of the L beam indication fields may be L×B_{BI}.

### [Fourth Exemplary Embodiment] Method for Determining Priority Between Control Information (e.g., DCIs, SCIs) Indicating Beams of the Repeater

When one or more control information (e.g., DCIs, SCIs) indicate application of different beams to a specific resource (e.g., time, frequency, and/or spatial resource), the repeater may select one control information based on at least one priority among the priorities listed in Table 28 below and may operate according to an indication of the selected control information. In other words, the repeater may receive first control information from the base station and receive second control information from the base station. If beam(s) indicated by the first control information are different from beam(s) indicated by the second control information, the repeater may perform communication using beam(s) indicated by control information with a higher priority based on Table 28 below.

TABLE 28

| Priority | Description |
|---|---|
| Priority 1 | The most recently-received control information (e.g., DCI, SCI) |
| | has a higher priority than previous control information. |
| Priority 2 | Control information indicating a wide beam has a higher priority |
| | than control information indicating a narrow beam. Alternatively, |
| | control information indicating a narrow beam has a higher priority |
| | than control information indicating a wide beam. |
| Priority 3 | Control information indicating a large number of time resources |
| | has a higher priority than control information indicating a small |
| | number of time resources. Alternatively, control information |
| | indicating a small number of time resources has a higher priority |
| | than control information indicating a large number of time |
| | resources. |
| Priority 4 | Control information indicating a large number of frequency |
| | resources has a higher priority than control information indicating |
| | a small number of frequency resources. Alternatively, control |
| | information indicating a small number of frequency resources has |
| | a higher priority than control information indicating a large |
| | number of frequency resources. |
| Priority 5 | Control information including ON-OFF signaling for the repeater |
| | has a higher priority than control information including beam |
| | indicating signaling. |
| Priority 6 | A priority of control information may be determined by priority |
| | configuration signaling for each control information. |
| | Alternatively, a priority of control information may be determined |
| | by a priority predefined for each control information format (e.g., |
| | DCI format or SCI format). |
| Priority 7 | Control information indicating a beam with a low index has a |
| | higher priority than control information indicating a beam with a |
| | high index. Alternatively, control information indicating a beam |
| | with a high index has a higher priority than control information |
| | indicating a beam with a low index. |

If control information (e.g., DCI, SCI) indicating a small number of time/frequency resources has a higher priority, the control information may override beam indication of control information with a lower priority. In this case, a beam update operation (e.g., beam replacement operation) may be performed within the time/frequency resources indicated by the control information with the higher priority. In other words, beam(s) indicated by the control information with the lower priority may be used in time/frequency resources other than time/frequency resources indicated by the control information with the higher priority.

The above-described exemplary embodiments are not necessarily exclusive when implementing the repeater. Combinations of various exemplary embodiments may be considered. For example, the repeater may determine a beam according to one of the methods of the first exemplary embodiment, and may perform a beam sweeping operation in a specific time/frequency resource according to the second exemplary embodiment. The beam determination operation and the beam sweeping operation may be performed simultaneously. The repeater may report information on supported function(s) and/or unsupported function(s) among the functions of the exemplary embodiment to the base station. The base station may determine operation(s) to be performed by the repeater based on the function(s) supported and/or function(s) not supported by the repeater, and indicate to the repeater the determined operation(s) through signaling.

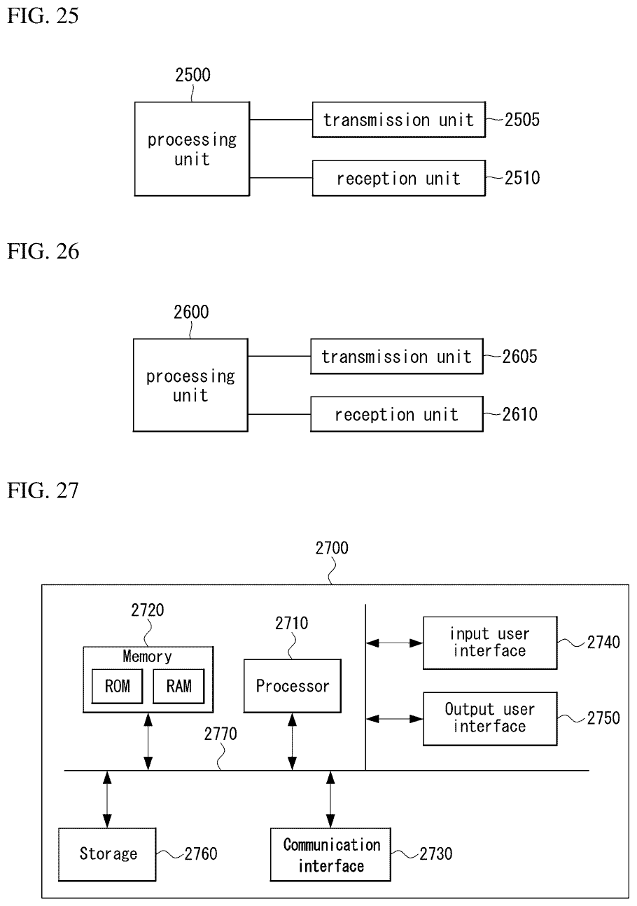

FIG. 25 is a block diagram illustrating a first exemplary embodiment of a base station.

Referring to FIG. 25, a base station may include a processing unit 2500, a transmission unit 2505, and a reception unit 2510. Each component of the base station may be subdivided. Alternatively, Some of the components of the base station may be integrated into one component. The processing unit 2500 may determine the overall operations of the base station and process the operations. For the above-described operation, the processing unit 2500 may store information and procedures, control the transmission unit 2505 to properly transmit signals, and control the reception unit 2510 to properly receive signals. The processing unit 2500 may determine which method(s) to use among the methods of the above-described exemplary embodiments, and may indicate the determined method(s) to the repeater.

FIG. 26 is a block diagram illustrating a first exemplary embodiment of a repeater.

Referring to FIG. 26, a repeater may include a processing unit 2600, a transmission unit 2605, and a reception unit 2610. Each component of the repeater may be subdivided. Alternatively, some of the components of the repeater may be integrated into one component. The processing unit 2600 may determine the overall operations of the repeater and process the operations. For the above-described operation, the processing unit 2600 may store information and procedures, control the transmission unit 2605 to properly transmit signals, and control the reception unit 2610 to properly receive signals.

FIG. 27 is a block diagram illustrating a first exemplary embodiment of a communication node.

Referring to FIG. 27, a communication node 2700 may include at least one of at least one processor 2710, a memory 2720, or a transceiver device 2730 that is connected to a network and performs communication. Additionally, the communication node 2700 may further include an input interface device 2740, an output interface device 2750, a storage device 2760, and/or the like. The respective components included in the communication node 2700 may perform communication with each other as being connected through a bus 2770.

However, each component included in the communication node 2700 may be connected through an individual interface or individual bus centered on the processor 2710, rather than the common bus 2770. For example, the processor 2710 may be connected to at least one of the memory 2720, the transceiver device 2730, the input interface device 2740, the output interface device 2750, and the storage device 2760 through dedicated interface(s).

The processor 2710 may execute program commands stored in at least one of the memory 2720 and the storage device 2760. The processor 2710 may refer to a central processing unit (CPU), a graphics processing unit (GPU), or a dedicated processor on which the methods according to the exemplary embodiments of the present disclosure are performed. Each of the memory 2720 and the storage device 2760 may be comprised of at least one of a volatile storage medium and a non-volatile storage medium. For example, the memory 2720 may be comprised of at least one of read only memory (ROM) and random access memory (RAM).

Meanwhile, regarding down-selection between Tₘₐₓ=1 or Tₘₐₓ=Lₘₐₓ, options for NCR may be considered in use cases below.
Use case #1: For beam sweeping in an access link, the base station may set Tₘₐₓ to 1 for aperiodic beam indication. In this case, indicated time resources may be evenly distributed among Lₘₐₓ beams.
Use case #2: For individual beam indication in an access link, the base station may set Tₘₐₓ to Lₘₐₓ for aperiodic beam indication. In this case, an association between time resource indication and beam indication may be one-to-one mapping.

The case where Tₘₐₓ is 1 and the case where Tₘₐₓ is Lₘₐₓ may have an advantage with respect to the NCR.

Support of Tₘₐₓ=1 and Tₘₐₓ=Lₘₐₓ for NCR may be considered.

In down-selection, Tₘₐₓ=1 may be preferable. The use cases for Tₘₐₓ=Lₘₐₓ may be covered by periodic beam indication.

The NRC may receive multiple beam configurations and/or beam indications at a given time instance for a variety of reasons. For example, the base station may configure a default beam and then update the beam according to a dynamic indication depending on a situation. For another example, if access link-specific CSI reporting is not supported, the base station may allocate a coarse beam and a narrow beam together for robustness. In this case, prioritization rules below may be considered to determine an actual beam for the access link.
Prioritization rule #1: The latest control information may have the highest priority. The latest control information may override previous control information.
Prioritization rule #2: Coarse beam indication may have a higher priority than narrow beam indication. A repeater beam hierarchy may be supported.

Prioritization rules for control information indicating beams during a given time instance may be supported.
Prioritization rule #1: The latest control information may have the highest priority. The latest control information may override previous control information.
Prioritization rule #2: Coarse beam indication may have a higher priority than narrow beam indication.

For access link beam update according to the prioritization rules, beam update may be applied in time resources indicated by the control information with a higher priority. For example, when control information with a second priority indicates beams in slots/symbols #0 to #9, and control information with a first priority indicates beams in slots/symbols #0 to #1, the NCR may update the beams in the slots/symbols #0 to #1 and maintain the remaining beams in the slots/symbols #2˜#9. Signaling overhead for the access link beam update can be appropriately maintained.

The beam update may be applied in time resources indicated by the control information with a higher priority. In other words, the beam indication may not override other beam indications other than the corresponding time resource indication.

The methods according to the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

1. A method of a repeater, comprising:
receiving first control information from a base station;
identifying one or more beams used by the repeater based on a beam indication field included in the first control information; and
relaying communication between the base station and a terminal by using the one or more beams.

2. The method according to claim 1, wherein the beam indication field is set to one of a beam index, a quasi-co located (QCL) index, a transmission configuration information (TCI) index, or an index of spatial relation information.

3. The method according to claim 1, further comprising: identifying a first time resource to which the one or more beams are applied based on a time resource field included in the first control information, wherein the communication between the base station and the terminal is relayed using the one or more beams in the first time resource.

4. The method according to claim 3, further comprising: receiving a signaling message including a time resource list from the base station, wherein the time resource field included in the first control information indicates the first time resource among one or more time resources belonging to the time resource list.

5. The method according to claim 1, further comprising: identifying a first frequency resource to which the one or more beams are applied based on a frequency resource field included in the first control information, wherein the communication between the base station and the terminal is relayed using the one or more beams in the first frequency resource.

6. The method according to claim 5, further comprising: receiving a signaling message including a frequency resource list from the base station, wherein the frequency resource field included in the first control information indicates the first frequency resource among one or more frequency resources belonging to the frequency resource list.

7. The method according to claim 1, further comprising: identifying one or more antennas to which the one or more beams are applied based on an antenna indication field included in the first control information, wherein the communication between the base station and the terminal is relayed using the one or more antennas, the one or more antennas include at least one of a first antenna or a second antenna of the repeater, the first antenna is used for communication between the repeater and the base station, and the second antenna is used for communication between the repeater and the terminal.

8. The method according to claim 1, further comprising: identifying whether to perform a beam sweeping operation based on a beam management mode field included in the first control information, wherein when the beam management mode field indicates to perform the beam sweeping operation, the communication between the base station and the terminal is relayed based on the beam sweeping operation.

9. The method according to claim 1, further comprising:
receiving second control information from the base station; and
identifying one or more beams used by the repeater based on a beam indication field included in the second control information,
wherein when the one or more beams indicated by the first control information are different from the one or more beams indicated by the second control information, the one or more beams used for relaying the communication between the base station and the terminal are determined based on priorities.

10. The method according to claim 9, wherein latest control information among the first control information and the second control information has a higher priority, and the one or more beams indicated by the latest control information are used to relay the communication between the base station and the terminal.

11. The method according to claim 9, wherein control information indicating a wide beam or a narrow beam among the first control information and the second control information has a higher priority, and the one or more beams indicated by the control information having the higher priority are used to relay the communication between the base station and the terminal.

12. The method according to claim 9, wherein control information indicating a large number of time resources or a small number of time resources among the first control information and the second control information has a higher priority, and the one or more beams indicated by the control information having the higher priority are used to relay the communication between the base station and the terminal.

13. The method according to claim 9, wherein control information indicating a large number of frequency resources or a small number of frequency resources among the first control information and the second control information has a higher priority, and the one or more beams indicated by the control information having the higher priority are used to relay the communication between the base station and the terminal.

14. The method according to claim 9, wherein control information indicating a beam having a high index or a low index among the first control information and the second control information has a higher priority, and the one or more beams indicated by the control information having the higher priority are used to relay the communication between the base station and the terminal.

15. A method of a base station, comprising:
generating first control information including a beam indication field indicating one or more beams used by a repeater and a time resource field indicating a first time resource to which the one or more beams are applied; and
transmitting the first control information to the repeater,
wherein communication between the base station and the terminal is relayed by the repeater using the one or more beams in the first time resource.

16. The method according to claim 15, wherein the beam indication field is set to one of a beam index, a quasi-co located (QCL) index, a transmission configuration information (TCI) index, or an index of spatial relation information.

17. The method according to claim 15, wherein the first control information further includes a frequency resource field indicating a first frequency resource to which the one or more beams are applied, wherein the communication between the base station and the terminal is relayed by the repeater using the one or more beams in the first time resource and the first frequency resource.

18. The method according to claim 15, wherein the first control information further includes an antenna indication field indicating one or more antennas to which the one or more beams are applied, wherein the communication between the base station and the terminal is relayed using the one or more antennas of the repeater, the one or more antennas includes at least one of a first antenna or a second antenna of the repeater, the first antenna is used for communication between the repeater and the base station, and the second antenna is used for communication between the repeater and the terminal.

19. The method according to claim 15, wherein the first control information further includes a beam management mode field indicating whether to perform a beam sweeping operation, wherein when the beam management mode field indicates to perform the beam sweeping operation, the communication between the base station and the terminal is relayed based on the beam sweeping operation of the repeater.

20. The method according to claim 15, further comprising: transmitting to the repeater second control information including a beam indication field indicating one or more beams used by the repeater, wherein when the one or more beams indicated by the first control information are different from the one or more beams indicated by the second control information, the one or more beams of the repeater used for relaying the communication between the base station and the terminal are determined based on priorities.
